(19) United States
(12) Patent Application Publication
(10) Pub. No.: US 2011/0270676 A1
(43) Pub. Date: Nov. 3, 2011

(54) Probabilistic Linking Approach for Serving Impressions in Guaranteed Delivery Advertising

(76) Inventors: Sergei Vassilvitskii, New York, NY (US); Jayavel Shanmugasundaram, Santa Clara, CA (US); Sumanth Jagannath, Sunnyvale, CA (US); Erik Vee, San Mateo, CA (US); Martin Zinkevich, Santa Clara, CA (US)

(21) Appl. No.: 12/771,196

(22) Filed: Apr. 30, 2010

(51) Int. Cl. G06Q 30/00; G06N 5/02

(52) U.S. Cl. 705/14.49; 706/52

(57) ABSTRACT

A computer-implemented method and display advertising server network for serving impression opportunities to a frequency-capped guaranteed delivery contract in a system for delivery of display advertising to a user. The method includes steps for receiving, from a computer, an event predicate and a user ID corresponding to the user, retrieving, from an index engine, a set of eligible frequency-capped contracts, wherein an eligible contract comprises at least one target predicate matching at least a portion of the event predicate, and probabilistically selecting for serving, in a computer, the booked contract having a frequency cap specification, only when the selected frequency-capped contract can be served to the user without violating the frequency cap specification. Exemplary embodiments include generating a pseudo-random number sequence, and then selecting a particular pseudo-random number from the series of pseudo-random numbers, the selected particular pseudo-random number being based on the user ID, a visit count, a URL.

### FIELD OF THE INVENTION

The present invention relates generally to advertising, and more specifically to the optimization of an advertisement delivery plan for allocating advertisements to frequency-capped contracts in a network-based environment.

### BACKGROUND OF THE INVENTION

The notion of “frequency capping” (i.e. limiting the number of times an advertisement is exposed to a particular viewer) has been a recognized notion within the advertising industry since the late 1970's, when research showed that an advertisement loses its effect on a viewer with repeated exposure. In the context of online display advertising, however, there has been relatively little work on frequency capping. Still, since advertising on the Internet provides the possibility of allowing advertisers to cost-effectively reach highly specific target audiences (e.g. individual viewers) the notion of frequency capping has gained attention, and Internet advertisers often demand (in the form of contractual obligations) that their advertisements do not become overexposed to a particular viewer/user. Fortunately, the Internet facilitates a two-way flow of information between users and advertisers and allows display decisions to be made in real time or near-to-real time. For example, a user may visit a web page, and may transmit various pieces of data describing himself or herself. Thus, it is conceptually possible for an advertising management system to be able to intelligently determine which ads to place (or not place) on a given website requesting advertisement content—e.g. using frequency caping or otherwise eliminating excessive re-display of the same ads—thus increasing the revenue for the parties involved and increasing user satisfaction.

Current systems, however, fail to fully exploit the interactive aspects of the Internet in the advertising realm. Most current advertising systems need to coordinate a number of components such as those for forecasting web traffic, for procuring ad placements based on target demographics, and for delivering display ads. Within this architecture, each component relies on the cooperative and reliable performance of the others. Unfortunately, current advertising systems are decoupled. A decoupled system results in a number of inconsistencies with respect to contracts for the promised placement and delivery of advertisements. Even just a slight overestimation of future web traffic may jeopardize an advertising system's ability to deliver the advertisements promised. Likewise, an underestimation of future web traffic hurts advertisers and publishers alike because of lost opportunities for ad placements.

Current systems create a strict and artificial separation between display inventory of available advertisement placements that is sold many months in advance in a guaranteed fashion (e.g. guaranteed delivery), and display inventory that is sold using a real-time auction in a market or through other means (e.g. non-guaranteed delivery). For instance, the Yahoo!® advertising system may serve guaranteed contracts their desired quota before serving non-guaranteed contracts, thus creating a possibly unnecessary and also possibly inefficient bias toward guaranteed contracts. While acceptable in the past, the shift in the advertising industry demands an efficient mix of guaranteed and non-guaranteed contracts.

Another flaw with the decoupled advertising system is the failure to take advantage of the stores of information available when pricing contracts and allocating advertisements to advertisement placements. For example, the current pricing systems use advertising information and contract information at a granularity and specificity that is coarse and untargeted. The failure to mine and use information regarding how advertisement placements may be allocated at a more granular level creates a gap between the price paid for an advertisement placement and the actual value that a contract derives from the advertisements placed.

This flaw leads to the inability of legacy systems to provide more refined and targeted advertisements, and increased refinement in targeting allows advertisers to reach a more relevant customer base. The frustration of advertisers moving from broad targeting parameters (e.g. “1 million Yahoo! Finance users”) to more fine-grained targeting parameters (e.g. “100,000 Yahoo! Finance users from September 2008-December 2008 who are males living in California and between the ages of 20-35 working in the healthcare industry”) is evident. Unfortunately, the increased refinement and targeting is not computationally pragmatic within the context of legacy system designs.

Accordingly, there exists a need for a more unified marketplace for the optimization of an advertisement plan and allocation of advertisements to a contract in a network-based environment.

### SUMMARY OF THE INVENTION

A computer-implemented method and display advertising server network for serving impression opportunities to a frequency-capped guaranteed delivery contract in a system for delivery of display advertising to a user. The method includes steps for receiving, from a computer, an event predicate and a user ID corresponding to the user, retrieving, from an index engine, a set of eligible frequency-capped contracts, wherein an eligible contract comprises at least one target predicate matching at least a portion of the event predicate, and probabilistically selecting for serving, in a computer, the booked contract having a frequency cap specification, only when the selected frequency-capped contract can be served to the user without violating the frequency cap specification. Exemplary embodiments include generating a pseudo-random number sequence, and then selecting a particular pseudo-random number from the series of pseudo-random numbers, the selected pseudo-random number being based on the user ID, a visit count, a URL.

### BRIEF DESCRIPTION OF THE DRAWINGS

The novel features of the invention are set forth in the appended claims. However, for purpose of explanation, several embodiments of the invention are set forth in the following figures.

FIG. 1 depicts an advertising server network environment including modules for implementing a probabilistic linking approach for serving impressions in guaranteed delivery advertising, in which some embodiments operate.

FIG. 2 depicts an index with target predicates in the form of an inverted index, in which some embodiments operate.

FIG. 3 depicts an allocation of impressions to contracts in the form of a bipartite eligibility graph, in which some embodiments operate.

FIG. 4 depicts a flowchart of a method for implementing a mass-based approach for serving impressions in guaranteed delivery advertising, in which some embodiments operate.

FIG. 5 depicts an exemplary data structure of a supply object, in which some embodiments operate.

FIG. 6 depicts an exemplary data structure of a demand object, in which some embodiments operate.

FIG. 7A depicts a bipartite allocation graph showing eligibility and links to a frequency-capped contract, in which some embodiments operate.

FIG. 7B depicts an annotated bipartite allocation graph showing eligibility and links to a frequency-capped contract and visit counters, in which some embodiments operate.

FIG. 7C depicts a system for probabilistic allocation of frequency-capped contract advertisements to user visits, in which some embodiments operate.

FIG. 8A depicts a flowchart of a method for implementing operations within a probabilistic policy for serving impressions in guaranteed delivery advertising, in which some embodiments operate.

FIG. 8B depicts a flowchart of a method for implementing operations within a mass-based approach for serving impressions in guaranteed delivery advertising, in which some embodiments operate.

FIG. 9 depicts a flowchart of a method for implementing operations within a probabilistic linking approach for serving impressions in guaranteed delivery advertising, in which some embodiments operate.

FIG. 10 depicts a system diagram of a system implementing operations within a probabilistic linking approach for serving impressions in guaranteed delivery advertising, in which some embodiments operate.

FIG. 11 depicts a flowchart of a method for delivery of display advertising to a user, in accordance with one embodiment of the invention.

FIG. 12 depicts a block diagram of a system to perform certain functions of an advertising server network, in accordance with one embodiment of the invention.

FIG. 13 is a diagrammatic representation of a network including nodes for client computer systems, nodes for server computer systems and nodes for network infrastructure, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### Introduction to Guaranteed Delivery Display Advertising

Guaranteed delivery display advertising is a form of online advertising whereby advertisers can buy a fixed number of targeted user visits in advance, and publishers guarantee these user visits. In case the guarantee is not met, the publisher incurs some penalty (monetary or otherwise), so it is in the best interest of the publisher to try and meet the guarantees. For example, a sports shoe manufacturer (an advertiser) can buy one hundred million user visits for males in California who visit Yahoo! Sports between 1 Jun. 2010 and 15 Jun. 2010, and Yahoo! (as a publisher) will guarantee these user visits even though the duration of interest occurs several months later than the current date.

The guaranteed delivery model of online display advertising is prevalent among the major advertising networks such as Yahoo!, AOL, and MSN, and represents a multi-billion dollar industry. One of the key advertiser requirements in the guaranteed delivery model is to limit the number of times a user sees an ad. Such a requirement is important for two reasons: (1) to ensure that a specific user does not get saturated with the ad, and (2) to ensure that the advertiser reaches many different users, rather than showing the ad to a few users many times. The feature to limit ad exposure to a particular user is called frequency capping, and a frequency capping specification typically specifies the frequency count and the frequency duration. For instance, if an advertiser wishes to limit the number of times a given user sees its ad to at most five times a day, then this would be specified with a frequency count of 5 and a frequency duration of 1 day. Then, observing the frequency capping specification, the ad would be shown to a given user at most 5 times in one day. That is, observing the frequency capping specification of a given frequency-capped contract means that the ad is displayed to a user at most a specified number of times (e.g. frequency count times) within a specified duration (e.g. within the period of a frequency duration).

Supporting frequency capping in a guaranteed delivery system presents challenges. One challenge is to be able to forecast user visits many months in advance so that guaranteed contracts with frequency caps can be underwritten by publishers. A basic forecasting model (disclosed herein) is necessary even for regular guaranteed contracts without frequency capping constraints, but various extensions—such as forecasting the number of user visits to various web sites—aid in providing a frequency capping option when booking guaranteed delivery contracts.

Another challenge presented in frequency capping stems from the fact that the booking system (which accepts guaranteed contracts many months in advance) and the ad serving system (which serves ads to users when they visit web pages) need to be closely synchronized so as to limit under-delivery penalties (and thus to maximize revenue). Specifically, if the booking system accepts larger and more contracts than can be served, this would result in under-delivery by the ad server. Conversely, if the booking system accepts fewer of smaller contracts than can be served, this would result in a loss of potential revenue to the publisher. However, achieving this synchronization in the presence of frequency capping is quite challenging due to the very different information and resources available at the time of booking versus at the time of serving. In particular, at the time of booking, only an approximate prediction of user behavior is available, although this information is available for all future dates of interest. In contrast, at the time of serving, the exact user visit information is available, but there is typically little or no information about future visits.

The above differences between the booking and serving systems have profound implications on frequency capping solutions. For instance, a simple approach might be as follows: At the time of booking, solve an allocation problem using forecast user visits and existing frequency-capped contracts to see if the addition of a new frequency capped contract is still feasible; if so, admit the new frequency capped contract, else reject it. Similarly, at the time of serving, solve the same allocation problem using current and predicted future user visits and booked frequency-capped contracts, then serve the ad corresponding to the contract allocated to the current user visit. However, this approach is often infeasible because it is not practical to obtain and optimize for all future visits at the time of serving. Alternative serving policies are presented infra.

### Overview of Networked Systems for Online Advertising

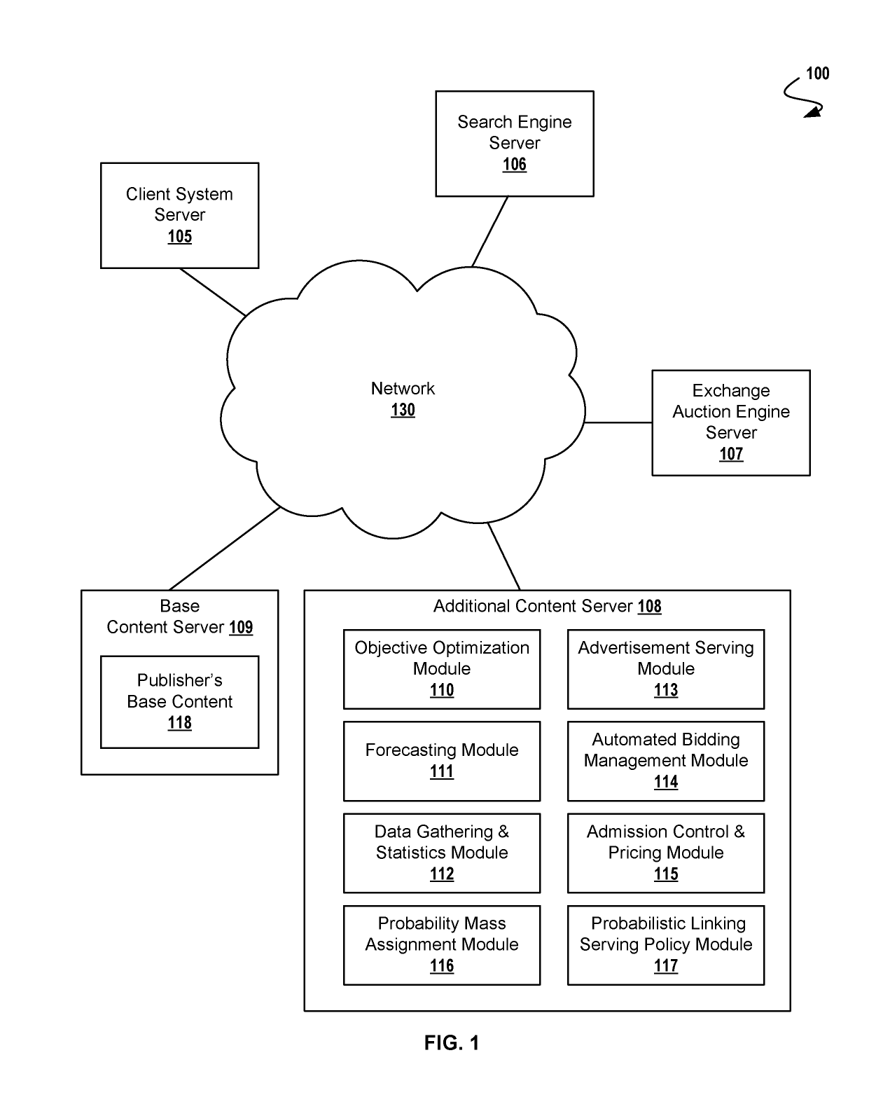

FIG. 1 depicts an advertising server network environment including modules for implementing a probabilistic linking approach for serving impressions in guaranteed delivery advertising, in which some embodiments operate. Otherwise stated, the advertising server network environment implements a system for delivery of display advertising. In the context of Internet advertising, placement of advertisements within an Internet environment (e.g. environment 100 of FIG. 1) has become common. By way of a simplified description, an Internet advertiser may select a particular property (e.g. Yahoo.com/Finance, or Yahoo.com/Search), and may create an advertisement such that whenever any Internet user, via a client system 105 renders the web page from the selected property, possibly using a search engine server 106, the advertisement is composited on a web page by one or more servers (e.g. base content server 109, additional content server 108) for delivery to a client system 105 over a network 130. Given this generalized delivery model, and using techniques disclosed herein, sophisticated online advertising might be practiced. More particularly, an advertising campaign might include highly-customized advertisements delivered to a user corresponding to highly-specific target predicates. Again referring to FIG. 1, an Internet property (e.g. a publisher hosting the publisher's base content 118 on a base content server 109) might be able to measure the number of visitors that have any arbitrary characteristic, demographic, target predicates, or attribute, possibly using an additional content server 108 in conjunction with a data gathering and statistics module 112. Thus, an Internet user might be ‘known’ in quite some detail as pertains to a wide range of target predicates or other attributes.

Therefore, multiple competing advertisers might elect to bid in a market via an exchange auction engine server 107 in order to win the most prominent spot, or an advertiser might enter into a contract (e.g. with the Internet property, or with an advertising agency, or with an advertising network, etc) to purchase the desired spots for some time duration (e.g. all top spots in all impressions of the web page empirestate.com/hotels for all of 2010). Such an arrangement, and variants as used herein, is termed a contract.

In embodiments of the systems within environment 100, components of the additional content server perform processing such that, given an advertisement opportunity (e.g. an impression opportunity profile, or an event predicate), processing determines which (if any) contract(s) match the advertisement opportunity. In some embodiments, the environment 100 might host a variety of modules to serve management and control operations (e.g. an objective optimization module 110, a forecasting module 111, a data gathering and statistics module 112, an advertisement serving module 113, an automated bidding management module 114, an admission control and pricing module 115, a probability mass assignment module 116, a probabilistic linking serving policy module 117, etc) pertinent to serving advertisements to users, including serving ads under guaranteed delivery terms and conditions. In particular, the modules, network links, algorithms, assignment techniques, serving policies, and data structures embodied within the environment 100 might be specialized so as to perform a particular function or group of functions reliably while observing capacity and performance requirements. For example, an additional content server 108, possibly in conjunction with a probabilistic linking serving policy module 117 might be employed to implement a probabilistic linking approach for serving impressions in guaranteed delivery advertising.

Booking and Serving within a Guaranteed Delivery Setting

In a guaranteed delivery setting, the publisher faces two major problems. The first is that of accurate booking—the publisher's goal is to sell all of its inventory to guaranteed contracts. The leftover inventory is typically sold on a non-guaranteed marketplace and fetches much lower prices. The second is that of accurate serving—given a set of booked contracts and a visit by a user, decide which of the eligible contracts to show to the user so that all of the contracts are satisfied.

A simple approach addressing these problems might be as follows: At the time of booking, solve an allocation problem using forecasted user visits and existing booked contracts to see if the addition of a new booked contract is still feasible; if so, admit the new contract, else, reject it. Similarly, at the time of serving, solve the same allocation problem using current and predicted future user visits and booked contracts, and serve the ad corresponding to the contract allocated to the current user visit. In some cases, this approach may be impractical because it may not be practical to obtain and optimize for all future visits at the time of serving. Note that if the ad server serves using a different—say, greedy—serving policy instead of solving the allocation problem, then it will under-deliver because it may not be able to find the feasible solution as was found in the earlier timeframe by the booking system.

Another approach might be to solve the allocation problem at the time of booking and then send the solution to the ad server so that it can simply ‘follow’ the solution. For instance, the solution produced by the booking system might look like:
Serve 1st Sports visit of User A on June 1 to Contract 1
Serve 2nd Sports visit of User A on June 1 to Contract 2
Serve 1st Finance visit of User B on June 1 to Contract 1

The ad server can then simply follow the solution and serve the ad corresponding to Contract 1 to the first visit of User A, and so on. However, this approach may not be feasible because (a) the solution is extremely large given tens of billions of impressions processed per day and, (b) while it is possible to predict the overall distribution of user visits, it is impossible to reliably predict which specific users are going to visit at a particular time.

Moreover, the above simple approach only partially addresses the problem of user frequency capping in guaranteed delivery display advertising, whereby advertisers can limit the number of times an ad is shown to the same user. Failing to observe frequency capping may lead to over-serving contracts and/or to violating contractual arrangements, either or both of which can lead to lost revenue and/or dissatisfied advertisers and/or users.

### Problem Statement Pertaining to Guaranteed Delivery Display Advertising

Given the limitations of the aforementioned simple approaches, two questions arise: Is there a way to leverage the time, resources, and approximate long-term forecast information available at the time of booking to produce a compact and generalizable plan for the ad server that can be used in real time to serve ads for actual user visits? Also, are there serving policies that can be used in real time to serve ads for actual user visits and which can guarantee satisfaction of frequency caps? The key requirements here are compactness, which ensures that the information can be meaningfully stored in the ad server; generalizability, which ensures that decisions made on approximate forecast information translate to meaningful actions on real user visits; and real-time execution, which requirement demands that the ad server can make reliable display advertising decisions within a span of time on the order of hundreds of milliseconds).

One solution to this problem is based on the aforementioned linking technique, whereby linking techniques predetermine which frequency-capped contracts are eligible for which user visits based on frequency cap constraints. Specifically, given a frequency capped contract with frequency count C and frequency duration D, the contract is deemed to be eligible for (i.e. linked to) at most C visits of a given user in duration D. The linking characteristics C and D, so defined, can be represented as network flow constraints on a bipartite graph involving supply (user visits) and demand (frequency-capped contracts). Thus, such a graph serves as a compact and generalizable plan that can be interpreted in real time by the ad server. It is also possible to solve the allocation problem quite efficiently at the time of booking.

The herein disclosed linking techniques may operate under one or more of a collection of linking policies, each of which policy aims to provide a different trade-off between forecast accuracy and under-delivery penalties while still guaranteeing that the frequency cap is satisfied.

### Booking and Serving Problem Formalization

Let I be the set of user visits and J be the set of contracts. Then denote a user visit using subscript i and denote a contract using subscript j. Each user visit i can be represented as a collection (e.g. set, vector) of attribute-value pairs (e.g. event predicates) that include the properties of the user, the properties of the web pages the user is visiting, and the time of the visit. For instance, a visit by a male user from New York interested in travel and visiting a Sports page on 31 Jan. 2010 at 10 pm might have a predicate represented as: Gender=Male, Location=New York, Category=Sports, Interests=Travel, Time=31 Jan. 2010 10 pm. Similarly, each contract j can be represented as one or more Boolean expressions characterizing the user visit attributes (e.g. event predicates). For instance, a contract that targets males visiting Sports pages in the month of January might have an event predicate represented as: Genderε{Male} [symbol] Categoryε{Sports} [symbol] Durationε[1 Jan. 2010, 31 Jan. 2010]. In addition, each contract j further specifies its demand, i.e. the number of user visits that are guaranteed to be shown, which is denoted by dⱼ. A plurality of contracts might be represented in an inverted index such that one or more contracts might be retrieved via the index using one or more predicates.

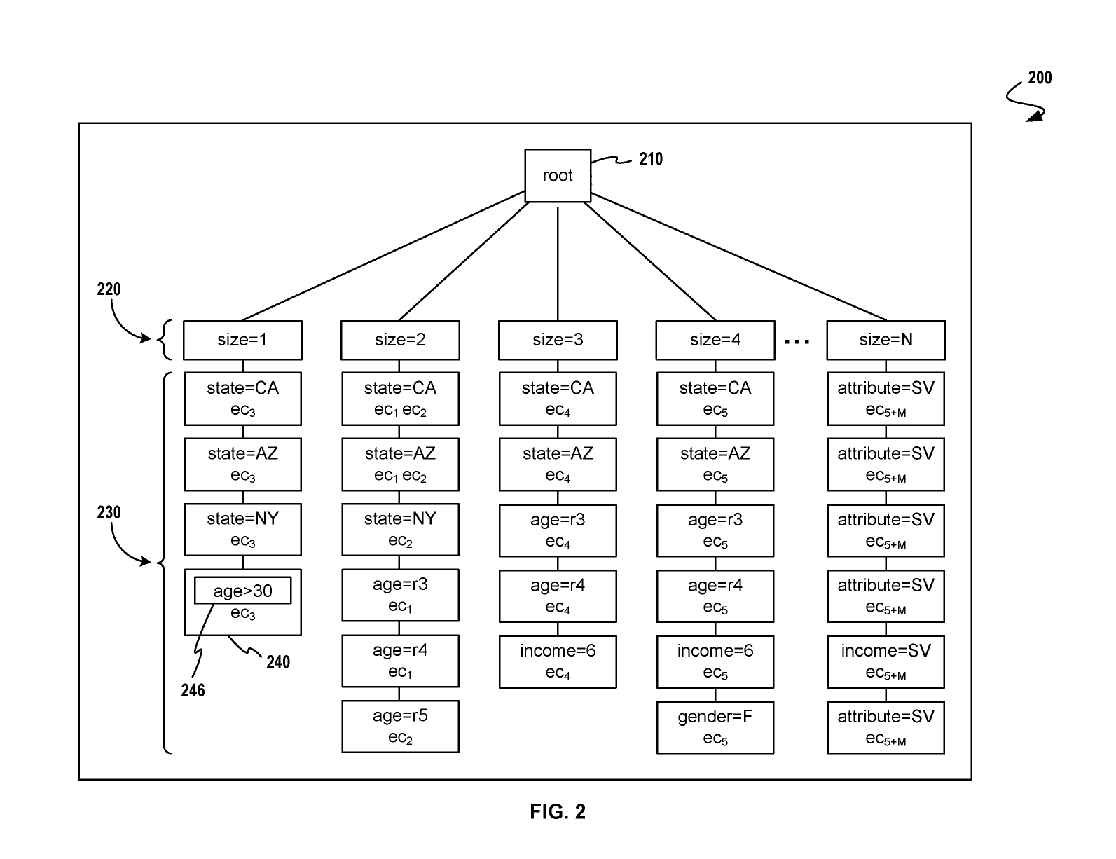

FIG. 2 depicts an index with target predicates 200 in the form of an inverted index. As an option, the inverted index may be implemented in the context of the architecture and functionality of the embodiments described herein. Of course, however, the index with target predicates 200 or any portion therefrom may be used in any desired environment. As shown, an index with target predicates 200 in the form of an inverted index comprises a tree structure stemming from an inverted index root 210 into the inverted index branches 220 (labeled as size=1, size=3, size=N) under which inverted index branches 220 are index predicate nodes 230. In the particular embodiment shown, the index predicate nodes 230 are labeled with a predicate (e.g. state=CA, state=AZ, etc), and with corresponding labels indicating one or more particular contracts (e.g. ec₁, ec₂, ec₃, etc) that might be satisfied with respect to the predicate of that node. For example, for the sample node 240, contract ec₃ might be eligible (at least in part) when the example target predicate 246 age>30 is true. Of course, the foregoing structure is only an illustrative example, and other structures are reasonable and envisioned.

In more formal terms, one might say that a user visit iεI is eligible for contract jεJ if (and only if) it satisfies the target predicates of j; it can also sometimes be said that j is eligible for i in this case. Thus, a bipartite eligibility graph can be constructed.

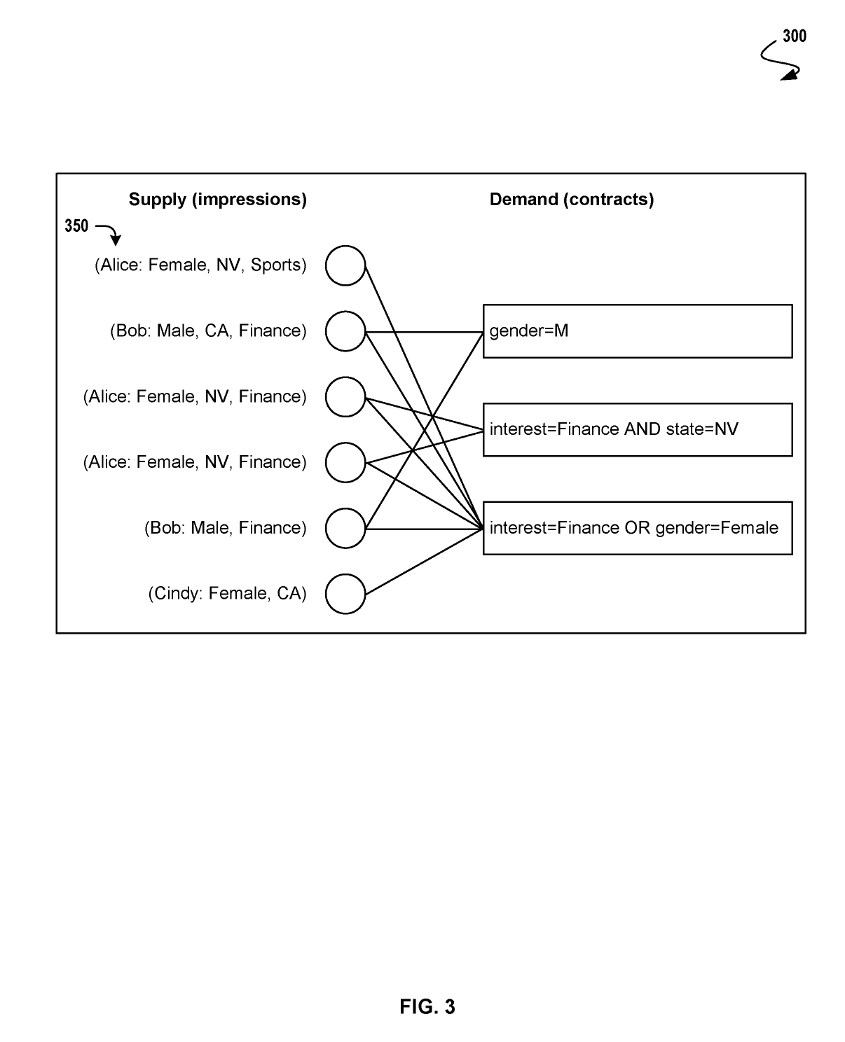

FIG. 3 depicts an allocation of impressions to contracts in the form of a bipartite eligibility graph 300.

The left-hand vertices (depicted as circles) consist of I (i.e. a supply of impressions); the right-hand vertices (depicted as rectangles) consist of J (i.e. demand from contracts). The edge-set, E, consists of edges (i, j) such that i is eligible for contract j. The set of user visits eligible for contract j is denoted by E(j). Likewise, the set of contracts eligible for i is denoted by E(i). Note that the eligibility graph shows the target predicates set annotated beside the contracts.

### Allocation Problem

In an exemplary allocation problem, a publisher may be associated with a set of booked contracts, and the publisher may posess information about future user visits, which forecast might be obtained from a forecasting module 111. One possible allocation problem goal can be described as follows: Find an allocation of user visits to contracts such that every user visit is allocated to at most one contract, and each contract j is allocated to at least dⱼ impressions. Let xε{0,1}^{E} denote the allocation. Then, by convention, set xᵢⱼ=1 to mean that the ad associated with contract j is shown for the impression i, and xᵢⱼ=0 otherwise.

The publisher may have some objective function, H:{0,1}^{E}→R, over the set of feasible allocations. Such an objective function generally relates the goals of revenue, advertiser satisfaction, and user happiness, though other objective functions are reasonable and envisioned. Thus, the allocation problem may be formally written as:

$$\begin{matrix}Maximize H ( x ) \\ \begin{matrix}s . t . ∀ j , {\sum }_{i ∈ E ( j )} {x}_{ij} \geq {d}_{j} & \text{subject to a demand constraint} \\ ∀ i , {\sum }_{j ∈ E ( i )} {x}_{ij} \geq 1 & \text{subject to a supply constraint} \\ ∀ i , j , {x}_{ij} ∈ \{ 0 , 1 \} & \text{subject to an integrality constraint}\end{matrix}\end{matrix}$$

However, the allocation problem itself presents many difficulties. A bipartite eligibility graph 300 corresponding to commercially reasonable characteristics might include billions of user visits (e.g. impression opportunities 350), and tens of thousands of contracts, resulting in trillions of edges in the bipartite eligibility graph 300.

One way to make the problem more tractable is to reduce the size of the overall problem by sampling from the set of user visits. For example, a sampling might be comprised from a uniform sample of, for example, 10% of user visits, then scale each of the demands appropriately (in this example dividing them by a factor of 10). Although a sampling may not be a perfect representation of the whole set sampled, the resulting problem is smaller by an order of magnitude, and thus might be easier to solve (especially for a small bipartite eligibility graph). However, even after sampling, the bipartite eligibility graph might still include many hundreds of thousands of edges, and the solution might become long, and might involve significant computing cycles.

A second complementary way of reducing the solution-time problem is to relax the integrality constraint, replacing it with the more flexible constraint, 0≦xᵢⱼ≦1, thus expressing xᵢⱼ as a probability of allocating i to j. Then in the allocation problem, the demand constraint holds in expectation.

A Chernoff bound may be used in this randomized algorithm to determine a bound on the number of runs necessary to determine a value by majority agreement—up to a specified probability. Since the typical demand is on the order of hundreds of thousands of impressions, an application of Chernoff bounds proves that any integral realization of the fractional solution will violate the demand by, at most, 1% with high probability. Using the above two techniques, the reduced allocation problem is usually solvable in practice (e.g. using one or more modules within an additional content server 108).

### Booking Problem

In the booking problem, the publisher has a set of already booked contracts and certain statistical predictions as well as other information about future user visits. In this booking problem, an advertiser wishes to book a new contract j′ targeting a specific subset of users iεE(j′). The goal of the publisher is to find the maximum amount of inventory that can be allocated to the new contract. That is, the publisher needs to solve the following variant of the allocation problem:

$$\begin{matrix}Maximize {\sum }_{i ∈ E ( {j}^{′} )} {x}_{{ij}^{′}} \\ \begin{matrix}s . t . ∀ j , {\sum }_{i ∈ E ( j )} {x}_{ij} \geq {d}_{j} & \text{subject to a demand constraint} \\ ∀ i , {\sum }_{j ∈ E ( i )} {x}_{ij} + {x}_{{ij}^{′}} \leq 1 & \text{subject to a supply constraint} \\ ∀ i , j , 0 \leq {x}_{ij} \leq 1 & \text{subject to a relaxed constraint}\end{matrix}\end{matrix}$$

The above booking problem may be expressed as a bipartite graph network flow, and thus solved quickly using modern computing techniques, especially since the above booking problem is subject to relatively few constraints. However, permitting the booking of contracts, including terms pertaining to frequency capping, introduces an additional (possibly large) set of constraints since there is a constraint (i.e. the frequency cap) for every user/contract pair. As earlier foreshadowed, various embodiments trade off the optimality of the solution with the total number of new constraints. That is, rather than approaching a booking and serving problem with literally trillions of constraints, a vastly fewer number of constraints can be considered while still guaranteeing that none of the frequency capping constraints are violated.

### Serving Problem

For purposes of fully explaining the serving problem including frequency capping constraints, it is useful to explain the serving problem without frequency capping constraints. That is, in the serving problem, the publisher wishes to implement a series of decisions that implement a feasible solution to the allocation problem. As each user visit occurs, the publisher (or agent for the publisher) must make an immediate and irrevocable decision as to which contract to serve. The goal is to make the series of serving decisions such that, at least approximately, the planned allocation is achieved. Of course, the challenge here lies in the dearth of information and lack of resources available at serving time.

For example, a serving policy that precomputes an allocation for each user visit may underperform as it may be impossible to forecast exactly how many times a user will appear. Furthermore, a desired allocation plan should be general enough to be able to handle new users that have never been part of the system before (and thus not considered in earlier forecasting). Several serving policies are given in Table 1.

TABLE 1
Possible serving policies (e.g. without considering frequency caps)

| Policy Statement | Effect in Expectation |
|---|---|
| Pre-compute an allocation and | Actual impressions arriving in future |
| implement that allocation | may differ from the allocation plan |
| Pre-compute an allocation and | Stateful allocation may require vast |
| implement that allocation | computing resources |
| Serve to oldest contract | May over-serve the oldest contracts |
| | while under-serving newer contracts |
| Serve to contract soonest to | May under-serve contracts until it is |
| expire | too late to catch up |

One possible solution to the serving problem is to run an offline optimization to produce an allocation plan, which can then be interpreted by an advertisement serving module 113. One way to generate an allocation plan is to observe an objective function for meeting guarantees of the guaranteed delivery contracts. In some embodiments, the essence of an allocation plan resides in a single number for each contract, called its mass.

### Serving Problem Solution Using a Mass-Based Approach for Serving Impressions in Guaranteed Delivery Advertising

When the ad server processes a user visit, it first finds the set of contracts eligible for the user visit. It then probabilistically allocates the user visit to one of the eligible contracts, where the probability of allocating the user visit to a contract is proportional to the mass of the contract. That is, if the user visit is eligible for k contracts with masses m₁, . . . , mₖ, then the user visit is allocated to contract j with probability mⱼ/Σᵢmᵢ.

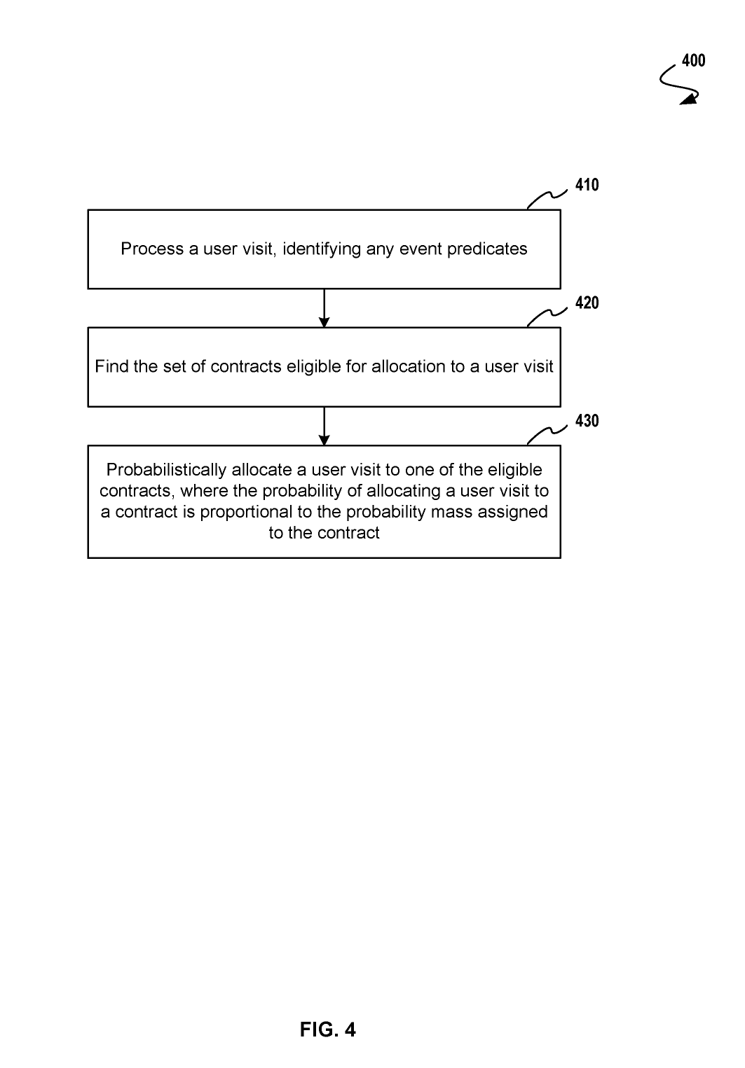

FIG. 4 depicts a flowchart of a method 400 for implementing a mass-based approach for serving impressions in guaranteed delivery advertising. As shown, the method commences when the ad server processes a user visit (see operation 410), then proceeds to find the set of contracts eligible for allocation to a user visit with demographics that are the same or similar to the specific user visit as may be indicated by one or more match operations between user events and the target audience of the contract (see operation 420). The operations of processing a user visit may include determining the event predicates (possibly using one more event predicate descriptors) corresponding to the visiting user. For example, a user might posess a cookie or other record indicating the demographics of the user. Following the example of FIG. 3, a visit by Cindy might be processed for determining the event predicates corresponding to “gender=Female, state=CA”.

The method 400 then probabilistically allocates the user visit to one of the eligible contracts, where the probability of allocating the user visit to a contract is proportional to the probability mass assigned to the contract (see operation 430).

In further detail, and following earlier disclosure, every contract is assigned a mass. A mass may be represented as a single positive number. At serving time, when a user visit arrives, first find the event predicates (see operation 410) and then find the set of eligible contracts (see operation 420). Next, allocate the user visit to one of these contracts at random, with a probability proportional to the contract's mass. That is, if the user visit eligible to be served to k contracts with masses m₁, . . . , mₖ, then the user visit is allocated to contract j with probability mⱼ/Σᵢmᵢ. In some cases there might exist more supply than can be consumed by the set of eligible guaranteed contracts. In such a case, an artificial contract (a ‘ghost contract’) can be added to the set of eligible contracts, the ghost contract serving as a proxy for a set of non-guaranteed contracts. Thus, when the ad server allocates a visit to such a ghost contract, it in effect allocates the user visit to a non-guaranteed contract.

### Simulating a Serving Problem Solution Using a Mass-Based Approach for Serving Impressions in Guaranteed Delivery Advertising

Now described is an iterative algorithm to calculate the masses that are then assigned to contracts. Initially, construct the left side of a graph similar to the form of the bipartite eligibility graph 300, and also construct the right side of a graph similar to the form of the bipartite eligibility graph 300. For each contract on the right side of the graph, initialize the mass of each contract to equal 1. Simulate what the delivery to each contract would be (in expectation) if each user visit appearing in the linked eligibility graph is served, based on the then current masses. In particular, for any setting of the masses, \vec{m}, define deliveryⱼ(\vec{m}) to be the expected delivery to contract j. That is,

$${delivery}_{j} ( {m}^{->} ) = {\sum }_{i ∈ {E}_{L} ( j )} {m}_{j} / {M}_{i} ,$$

where for each i, Mᵢ=Σ_{j′εE}_{_{L}}₍ᵢ₎m_{j′}. Notice that for any γ>0, deliveryⱼ(γ\vec{m})=deliveryⱼ(\vec{m}).

For each contract j, increase its mass in proportion to its demand divided by its expected delivery, deliveryⱼ. If a contract j is under-delivering, then iterate the simulation and update until all demands are satisfied. In some embodiments, the demand may be padded by a padding value ε to ensure better convergence. The pseudo-code is given in Algorithm 1 below.

By virtue of its stopping condition, Algorithm 1 is guaranteed to produce an allocation plan that ensures every contract meets its demand (in expectation), so long as the algorithm actually stops. In fact, it can be shown that it is guaranteed to converge, so long as the demands of all contracts (padded by (1+2ε)) are feasible. In practice, the demand of contracts can be trimmed somewhat to ensure feasibility.

Algorithm 1: Assigning a mass to a contract
by simulating a series of supply events

Input: The linked eligibility graph, and padding value ε > 0
Result: The masses, mⱼ, for all contracts j are set appropriately
Initialize mⱼ = 1 and delivery ⱼ= 0 for all contracts j;
while delivery ⱼ< dⱼ for some j do

// Compute the expected delivery for each contract;
Set delivery ⱼ= delivery ⱼ(\vec{m}).;
// Update the masses;
foreach contract j do

mⱼ = mⱼ ×max(1,(1 + ε)dⱼ/ delivery ⱼ);

end

end

### Frequency Cap Problem Formal Description

Recall that in addition to the total demand dⱼ, each contract j may impose a frequency cap cⱼ over a time duration or window t. The frequency cap is the maximum number of times the contract's ad may be shown to a given user during the time duration. Typically, the time duration is a hard interval, like a day, an hour or a week; and is reset at some pre-specified time (for example midnight UTC). As used herein, the examples indicate that the time window is one day, and is reset at midnight.

Now, referring again to the bipartite graph of FIG. 3, it is possible to partition the supply impressions I into user sets, where each user set U has an associated user and day, and consists of all user visits that come from that user during that day. Denote the collection of such user sets by U. The frequency capping constraint can then be added to the above allocation problem by ensuring that:

$$∀ j , U ∈ ⋃ , {\sum }_{i ∈ U ⋒ E ( j )} {x}_{ij} \leq {c}_{j} \qquad ( FC constraint )$$

At first glance, this FC constraint is merely one more constraint among the other set of constraints handled in the allocation problem, and thus appears reasonable to be handled as in the regular allocation problem (without frequency capping). However, this FC constraint presents a new set of challenges to the problem:
Scale: While the frequency capping constraint has a very concise representation, it results in O(|U|·|J|) new constraints, whereas the total number of supply and demand constraints is only O(|I|+|J|). It is safe to assume that the number of users (i.e. |U|) is proportional to the number of user visits (i.e. |I|), and so the new formulation has a quadratic number of constraints. Recalling that |U| is in the tens of millions and |J| is in the tens of thousands, this simple requirement results in trillions of additional constraints, making the problem of solving for the optimal allocation an intractable problem.
Randomized Rounding: One of the simplifying assumptions made in the allocation problem was to relax the integrality constraint xᵢⱼ ε{0,1} to a fractional constraint 0≦xᵢⱼ≦1. That is, while the demand constraint only holds in expectation, with high probability that it would be approximately satisfied. However, it is not hard to see that such a probabilistic interpretation fails to work with the FC constraint. Although the FC constraint appears to hold in expectation, it actually leads to delivering less than intended. This is due to the fact that a publisher is prohibited from serving (or recognizing revenue) for more than cⱼ impressions to one user. Thus, an integral realization of the fractional allocation under-delivers, and in some cases it under-delivers severely.
Compactness and Generalizability. As mentioned earlier, existing network flow techniques for producing a compact allocation plan do not generalize conveniently to frequency capping constraints. Ostensibly, the network flow techniques must first predict the exact set of users that will arrive, since the allocation is specific to the constraints for every user. Further, for every such user, the number of times she will visit the publisher's website must be predicted exactly so that the allocation is realizable (for instance, if the forecast indicates that a specific user will arrive 10 times in expectation, but in reality the specific user only arrives 5 times, then the ad server would under-deliver). However, forecasts are only a rough prediction of the future based on past behavior.

### Supply Model and Supply Object

As described herein, the basic unit of supply is an individual user visit, which is identified by a set of event predicates (e.g. attribute-value pairs) that include information about the user and the context of the visit. Specifically, a user visit may be defined by the following:
User Information: Demographic information such as age, gender, income; inferred behavioral attributes such as “interest in sports” or “interest in financer”; geographic information such as country, state, city or zip; etc.
Content Information: Information regarding the specific web page visited in the publisher's content hierarchy such as site or section; specific keywords related to the visited web page, an Internet property URL, etc.
Time Stamp: A time stamp of the user visit (e.g. coded in UTC time format).
Event Predicate: A Boolean expression over the attribute space A₁×A₂× . . . ×A_{K} that specifies characteristics of the corresponding user visit. For example, suppose there are k=1, . . . , K attributes that specify the user and content information, with the set of allowable values for attribute k being denoted by Aₖ. Then the combination of the user information (expressed as an event predicate) and the content information (also expressed as an event predicate) can be represented as a Boolean expression over the attribute space A₁×A₂× . . . ×A_{K}. For example, the event predicate of a user visit by a male in the U.S. who is visiting non-Spanish pages with content on the topic of the NBA could be represented as:

(Gender=Male [symbol] Country=US [symbol] Language≠Spanish [symbol] Contenttopic=NBA)

Now suppose that there are k=1, . . . , K attributes that specify the user and content information, with the set of allowable values for attribute k being denoted by Aₖ. It is easily seen that the predicate (in this case, used as an event predicate) could specify any subset of the universe of attribute-values of a user visit, i.e. an element of the set 2^{A}^{₁}^{× . . . ×A}^{_{K}}.

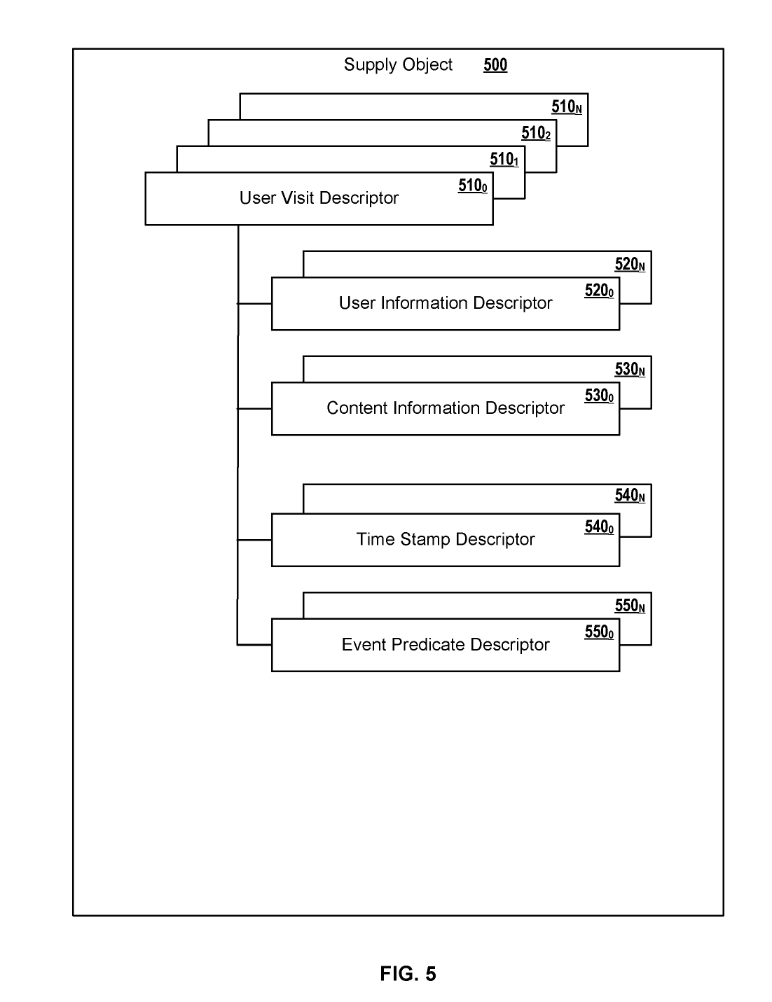

FIG. 5 depicts an exemplary data structure of a supply object 500. As described above, an individual user visit may be identified by a set of predicates (e.g. attribute-value pairs) that includes information about the user and the context of the visit. Thus, an exemplary supply object 500 might comprise one or more user visit descriptors 510₀-510_{N}, which in turn may be associated with one or more user information descriptors (IDs) 520₀-520_{N}, (possibly including a user ID in the form of a number, or in the form of an aggregated data type in the form of a user information descriptor), one or more content information descriptors 530₀-530_{N}, one or more time stamp descriptors 540₀-540_{N}, and one or more event predicate descriptors 550₀-550_{N}. In some embodiments, an event predicate descriptor might codify an event predicate as a Boolean expression in an appropriate computer-readable form.

### Demand Model and Demand Object

As discussed herein, the basic unit of demand is a guaranteed contract. In particular, a typical guaranteed delivery contract (denoted as c) may specify the following:
Target Predicate: A Boolean expression over the attribute space A₁×A₂× . . . ×A_{K} that specifies the set of user visits eligible for the contract. For example, the target predicate of a guaranteed contract that targets males in the U.S. who visit non-Spanish pages with content topics NBA or NFL could be represented as:

(Genderε{Male} [symbol] Countryε{US} [symbol] Language∉{Spanish} [symbol] ContentTopicε{NBA,NFL})
Thus it is easily seen that the target predicate could specify any subset of the universe of attribute-values of a user visit, i.e. an element of the set 2^{A}^{₁}^{× . . . ×A}^{_{K}}.

Frequency Cap Specification:
Frequency Cap Count: The maximum number of user visits for which the advertiser's advertisement can be displayed within the Frequency Cap Duration.
Frequency Cap Duration: A value that specifies a time duration (e.g. 1 day), or the start and end times of the duration (e.g. coded in UTC time format). For instance, the start time of a duration could be 24 May 2010 at 10 am and the end time of the duration could be 14 Aug. 2010 at 11 pm.

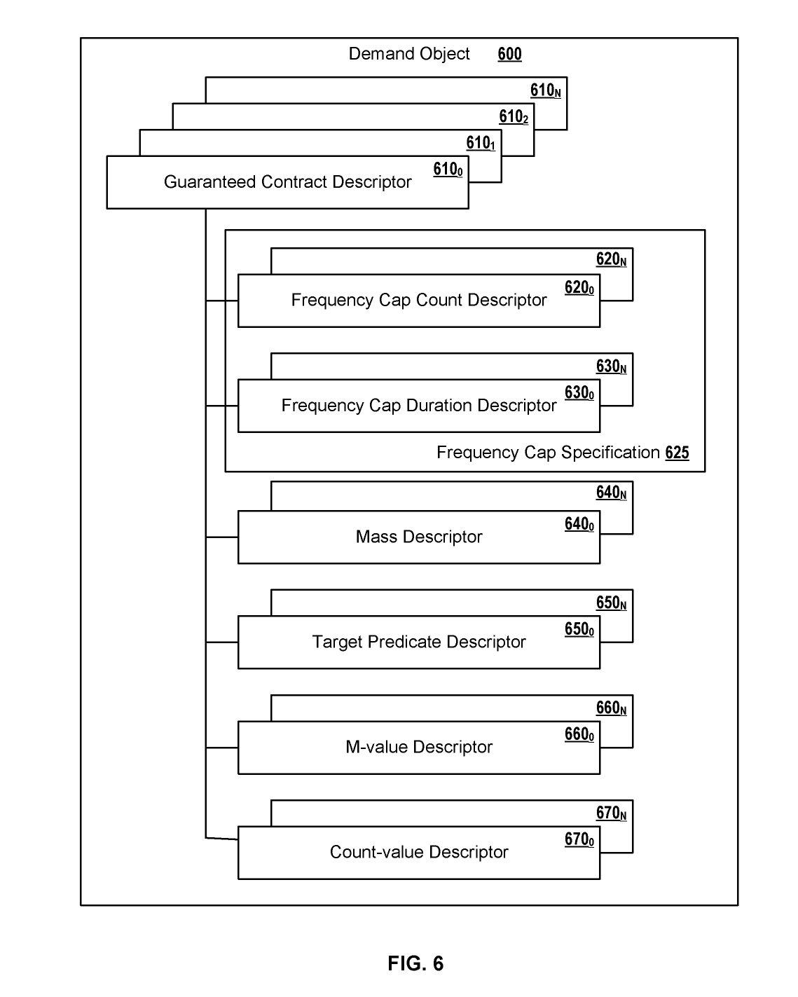

FIG. 6 depicts an exemplary data structure of a demand object 600. An exemplary demand object 600 might comprise one or more guaranteed contract descriptors 610₀-610_{N}, which in turn may be directly associated with one or more frequency cap count descriptor 620₀-620_{N}, one or more frequency cap duration descriptor 630₀-630_{N}, one or more mass descriptors 640₀-640_{N}, and one or more target predicate descriptors 650₀-650_{N}. A guaranteed contract descriptor might be directly associated with one or more M-value descriptors 660₀-660_{N} and one or more count-value descriptors 670₀-670_{N}.

### Linking Solution to the Frequency Cap Problem

The key intuition behind linking is to ensure that each contract j with frequency cap cⱼ is connected to at most cⱼ nodes from the same day (or alternate duration) from the same user in the eligibility graph. In other words, an a priori decision is made to link each frequency capped contract to at most cⱼ user daily visits from the same user. Consequently, any solution to the allocation problem based on the linked eligibility graph, ignoring frequency cap constraints, nevertheless still satisfies the frequency capping constraints of the contracts since the supply of each contract j from a given user is limited to cⱼ. To better understand this linking approach to solving the frequency capped version of the problem, consider the form of any feasible integral solution. In any feasible solution, for any frequency capped contract j with a cap of cⱼ, and for any user set U, at most cⱼ edges in E(j)∩U have a non-zero xᵢⱼ. So, rather than enforcing the FC constraints explicitly, one could instead find a subset of edges from E(j)∩U , denoted L_{U} (j), and require that xᵢⱼ=0 unless iεL_{U}(j). Then, if |L_{U} (j)|≦cⱼ for all U and j, the FC constraint is necessarily satisfied. Hence, the optimization problem can be rewritten as finding x and L_{U} (j) for all U, j in order to:

$$\begin{matrix}Maximize H ( x ) \\ \begin{matrix}s . t . ∀ j , {\sum }_{U ∈ ⋃} {\sum }_{i ∈ {L}_{U} ( j )} {x}_{ij} \geq {d}_{j} & \text{Demand constraint} \\ ∀ i , {\sum }_{j ∈ E ( i )} {x}_{ij} \leq 1 & \text{Supply constraint} \\ ∀ j , U ∈ ⋃ , \vert {L}_{u} ( j ) \vert \leq {c}_{j} & FC \text{constraint} \\ ∀ i , j , {x}_{ij} ∈ \{ 0 , 1 \} & \text{Integrality constraint}\end{matrix}\end{matrix}$$

By definition, if iεL_{U}(j), then i is linked to j. Observe that no more than cⱼ user visits are linked to j, for any user. Therefore, regardless of the found allocation, the frequency capping constraint will always be satisfied.

Another important observation is that if the FC constraint is enforced during eligibility graph construction; that is, only including the edges in |L_{U}(j)| in the eligibility graph for all frequency-capped contracts j, then it is unnecessary to include the FC constraint at the time of allocation optimization. Consequently, the remaining linear program only has O(|I|+|J|) constraints. Further, since frequency cap constraints can never be violated, it also lends itself to a probabilistic interpretation.

More formally, the sets L_{U} (j) induce a subgraph of the original eligibility graph. Define E_{L} to be the set of edges (i, j)εE such that i is linked to j, and refer to this induced subgraph as the linked eligibility graph. Thus, in effect, the resulting graph is a restriction of the original allocation problem with frequency capping.

Of course, still remains is the problem of finding the appropriate L_{U} (j) sets—or linking policies—which is discussed next. Note, however, that any set L_{U} (j) that satisfies the constraint that ∀j, UεU,|L_{U} (j)|≦cⱼ will yield a feasible solution to the allocation problem.

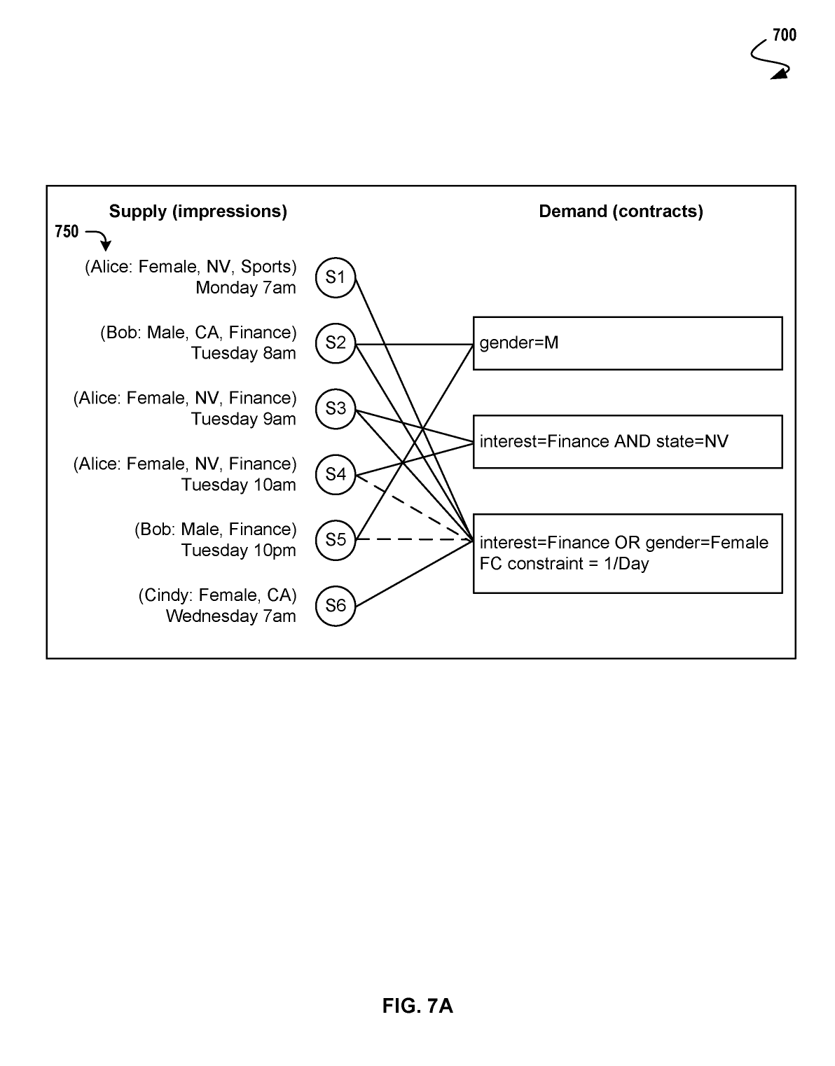

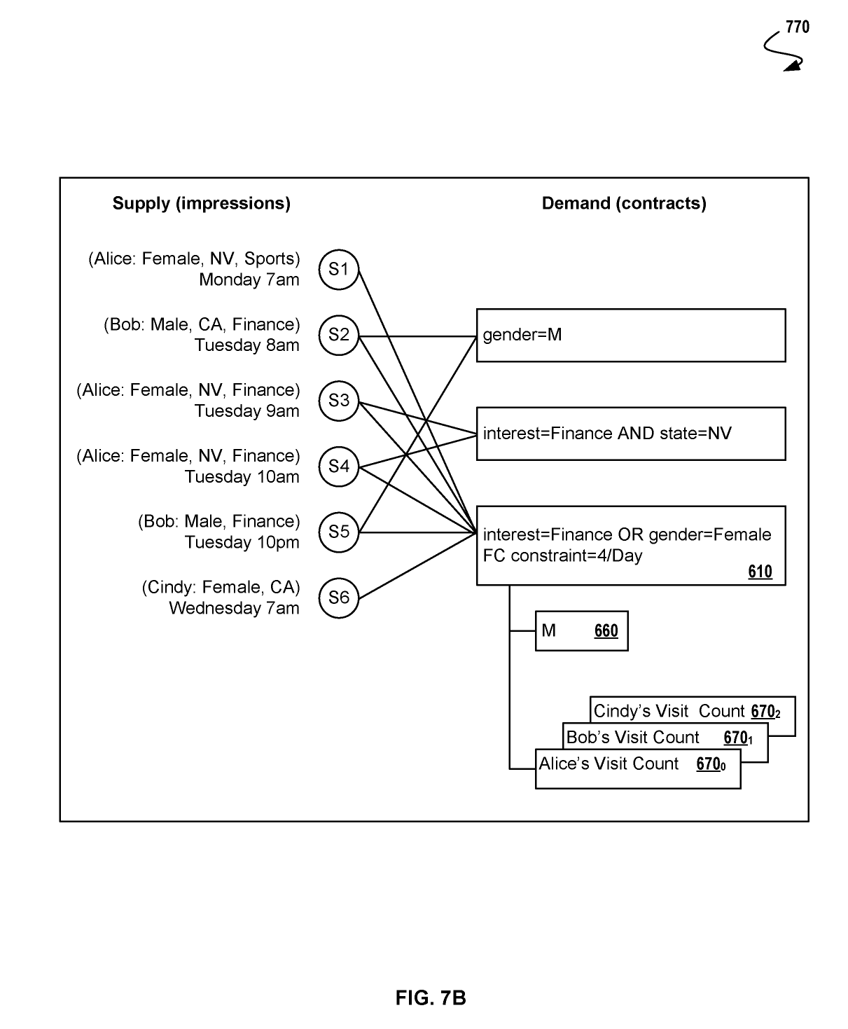

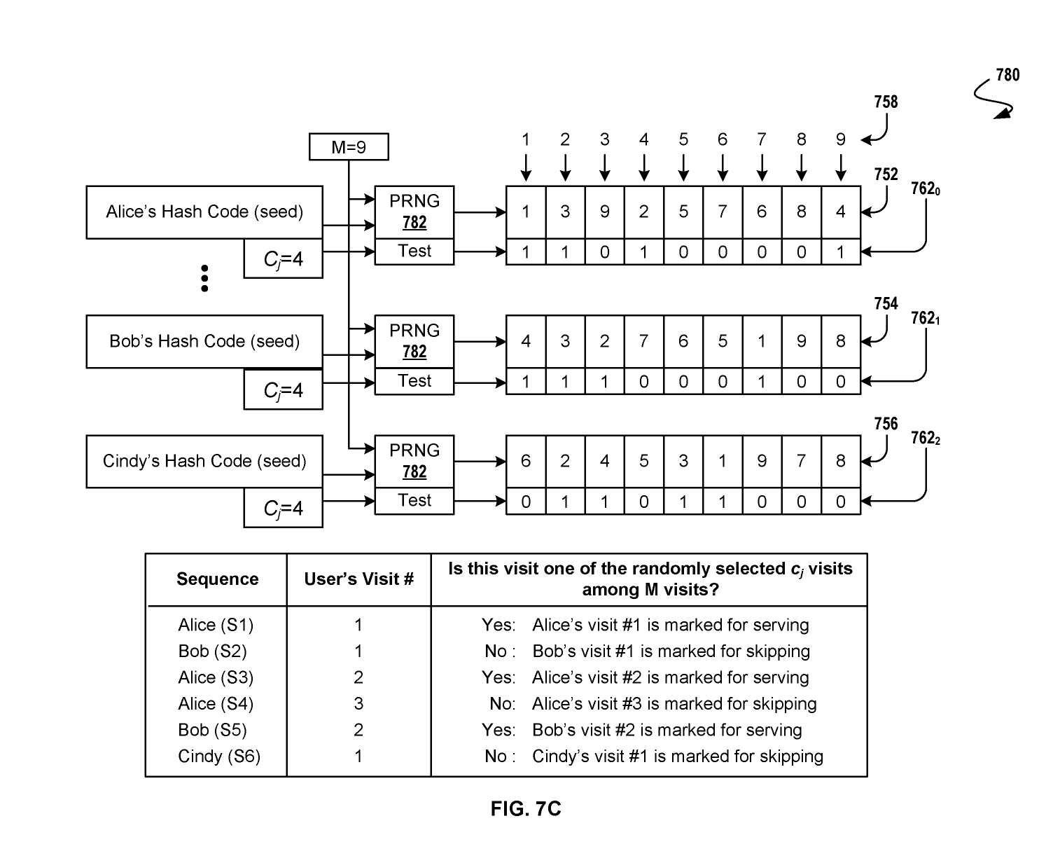

FIG. 7A depicts a bipartite allocation graph 700 showing eligibility and links to a frequency-capped contract. Of course, the bipartite allocation graph 700 is an exemplary embodiment, and some or all (or none) of the characteristics mentioned in the discussion of bipartite allocation graph 700 might be carried out in any environment. This graph is for illustrative purposes, and shows a series of user visits 750, labeled as {S1, S2, S3, S4, S5, and S6} spanning three days from three unique users—Alice, Bob and Cindy—in allocation to three contracts: one targeting male users, one targeting users visiting the Finance website from Nevada, and one targeting users who are Female or visiting the Finance website, respectively. The third contract specifies a frequency cap of 1 per day. Therefore while Alice has three visits {S1, S3, and S4} where the third contract is eligible, only one of those visits {S1} is linked to the contract. Similarly, Bob is eligible for the contract twice, but is linked to it only once. The dashed lines show contracts that are eligible (jεEᵢ) but are not linked (i∉L_{U}(j)).

Serving Policies with Frequency Capped Contracts

Table 2 introduces some serving policies considering frequency capped contracts

TABLE 2
Possible serving policies (e.g. considering frequency caps)

| Policy Statement | Effect in Expectation |
|---|---|
| Display to the first cⱼ visits | Tends to result in underbooking; tends |
| | to score low in representativeness. |
| Randomly Select a set of | Tends toward more optimal delivery with |
| Visits from among all | respect to booking goals; deliveries tends |
| expected visits in the time | to be more representative in aggregate |
| period | |

One simple linking policy is to link a contract with frequency cap cⱼ to the first cⱼ eligible visits of each user. At first glance, this approach has merit. First, the L_{U} can be compactly described (in effect, the description only needs to include cⱼ) and hence can be used as a compact plan at the time of ad booking and serving. Second, only a count of previous user visits needs to be stored in order to enforce the linking policy. Finally, it makes the forecasting problem tractable because it is only needed to be known what fraction of eligible user visits are among the first k for a user; i.e. there is no need to be able to predict the behavior of individual users.

However, the above simple linking policy can be improved upon. In particular, limiting a contract to linking to only the first few user visits potentially leaves the potential for many later user visits that cannot be served to frequency cap contracts. This leads to under-booking, which could result in a significant loss of revenue. Another behavior observed that can be improved upon with this approach is that frequency-capped contracts are given priority over the first few visits of a user, which earlier user visits are considered by advertiserts to be of particularly high value. Thus, as a result of giving priority to frequency-capped contracts, other contracts that are not frequency capped may receive only later, possibly lower-valued user visits, which may violate properties such as representativeness, which property is often important to advertisers.

Another policy can be stated as: “Randomly select a set of visits from a user from among all expected visits from that user in the time period”. Fortunately, this policy statement leads to a family of linking policies that enable a trade-off between under-booking and representativeness. The key idea is as follows. Instead of linking to the first cⱼ opportunities, one can probabilistically link to exactly cⱼ of the first M opportunities, for some M≧cⱼ. For example, if M=10, and there was contract 1 with a cap of 3 and contract 2 with a cap of 5, then the first time a user visited, this approach would assign the third, sixth, and ninth visit to link to contract 1, and the first, third, fourth, fifth, and eighth visits to link to contract 2.

This probabilistic linking policy shares many of the desirable properties of the simple linking policy. For example, the probabilistic linking policy can be compactly described because it is only needed to store M either for each contract (e.g. M-value descriptor 660), or for a set of contracts targeting similar users. Second, as in the simple linking policy, only a count of previous user visits (e.g. Count-value descriptor 670) by a particular user needs to be stored to enforce the linking policy. Third, it is also easy to forecast because cⱼ/M of the first M user visits are expected to be available, and furthermore, there is no need to forecast exact user visits. In addition, the probabilistic linking policy also addresses some of the undesired behaviors observed with the simple policy. Specifically, it addresses the issue of under-booking because a larger fraction of user visits are available to be served to frequency-capped contracts. It also addresses the issue of representativeness because frequency-capped contracts are linked to a large set of user visits, not just the first few visits.

### DETAILED EMBODIMENTS

Embodiments disclosed herein consider the following:
Assignment of a value for M.
A compact way of encoding an indication of which cⱼ user visits of a given user are eligible for a particular contract j (e.g. when encoding for a compact allocation plan).

Consider the solutions to choosing an appropriate M. Recall that one of the undesired behaviors of a simple linking policy to link a contract with frequency cap cⱼ to the first cⱼ eligible visits of each user is because that would have meant that a large fraction of the impressions were unavailable to be served to frequency-capped contracts. However, setting the value of M to be the median visit number of all user visits, then by definition half the opportunities would be available to frequency-capped contracts. A different value for M might be selected such that 25%, 75%, or even 100% of the user visits were available for frequency-capped contracts. In general, there is a trade-off in selecting M. In particular, the smaller M is, the more impressions that can be booked and served to an individual contract because not all users may visit as many times as indicated by a large M. The larger M is, the more impressions that can be booked to frequency-capped contracts overall, and the more representative the allocation to contracts. Consequently, varying M results in a family of linking policies.

As regarding solutions for compactly encoding which cⱼ eligible visits by a user are linked to a contract j, instead of explicitly storing the visit numbers for each (user, contract) pair, embodiments pseudo-randomly generate a (deterministic) sequence of cⱼ numbers between 1 and M using a hash code (e.g. using the user ID and the contract ID) as the random seed. Consequently, given a user u and contract j, it is always guaranteed to be able to (re-)generate the same sequence of cⱼ visit numbers, thereby never violating the frequency cap. Furthermore, this solution is quite compact—it only needs the IDs of users and contracts (which are generally available in any case to identify users and contracts even if a linking policy is not enforced). Finally, this solution also generalizes to new users because the new user IDs are simply used as seeds in the sequence generator, and the value M only has to capture the aggregate statistical behavior of such users.

FIG. 7B depicts an annotated bipartite allocation graph 770 showing eligibility and links to a frequency-capped contract and visit counters. Of course, the annotated bipartite allocation graph 770 is an exemplary embodiment, and some or all (or none) of the characteristics mentioned in the discussion of the annotated bipartite allocation graph might be carried out in any environment. As shown, the annotated bipartite allocation graph 770 includes a depiction of a guaranteed contract descriptor 610 as well as a data element for M (e.g. the M-value descriptor 660) and several user visit counts (e.g. the count-value descriptors 670₀, 670₁, and 670₂). In this case, and as further described in the discussion of FIG. 7C, the guaranteed contract descriptor 610 includes an FC constraint of 4/day. That is, the guaranteed contract descriptor 610 might include a frequency cap count descriptor 620 (not shown) with value set to “4”, and the guaranteed contract descriptor 610 might include a frequency cap duration descriptor 630 (not shown) with value set to “1 day”, thus representing the semantics of an FC constraint of “4” per “1 day”.

FIG. 7C depicts a system for probabilistic allocation of frequency-capped contract advertisements to user visits 780. Of course, the system for probabilistic allocation of frequency-capped contract advertisements to user visits 780 is an exemplary embodiment, and some or all (or none) of the characteristics mentioned in the discussion of the system for probabilistic allocation of a frequency-capped contract advertisements to user visits might be carried out in any environment. As shown, a system for probabilistic allocation of frequency-capped contract advertisements to user visits 780 includes a pseudo-random number generator 782 that accepts a hash code as a pseudo-random number generator seed and an integer value for M (e.g. an M-value descriptor 660). The pseudo-random number generator 782 is iterated M times in order to generate a pseudo-random number sequence, each pseudo-random number being mapped to an integer value in the range [1, 9]. For example, Alice's hash code is used as a seed for generating a first series of pseudo-random numbers (e.g. a pseudo-random number sequence 752), of M discrete integers, each discrete integer being an element of the pseudo-random number sequence. Similarly, for example, Bob's hash code is used as a seed for generating a second pseudo-random number sequence 754, of M discrete integers, and Cindy's hash code is used as a seed for generating a third a pseudo-random number sequence 756, of M discrete integers. Further, each element in the sequence might be labeled with a sequence indicator (e.g. sequence index indicators 758). Then, a test resulting in a binary Yes/No indication might be performed on each element of a pseudo-random number sequence for a particular user to create a user-specific serve-skip indication 762. The serve-skip indication test can be described as, “Is the pseudo-random number sequence element at this sequence indicator one of the cj visits for this user?”. If so, the test result is “1” (as shown). If not, the test result is “0” (as shown). If the sequence index indicators 758 are considered to correspond to successive visits, then a first, second, third . . . . Nth visit by a particular user can be determined to be a visit for which this contract should be served to this user merely by considering the test result.

Continuing with this example, and more particularly, the user visit sequence of {S1, S2, S3, S4, S5, S6} as shown in the annotated bipartite allocation graph 770 would result in the serving/skipping decisions shown in Table 3.

TABLE 3
Possible serving sequence (e.g. considering frequency caps)

| Policy Statement | S1 | S2 | S3 | S4 | S5 | S6 |
|---|---|---|---|---|---|---|
| Display to the first cⱼ visits | Yes | No | Yes | No | Yes | No |
| for a given user | | | | | | |

It should be noted that within any pseudo-random number sequence of M discrete integers there are no more than cj randomly assigned elements that result in a “1” serving test function result. Thus, it is always guaranteed that the frequency cap of cj serving decisions will always be observed. Even if M is increased, making the pseudo-random number sequence longer, there are no more than cj randomly assigned elements that result in a “1” serving test function result within the sequence.

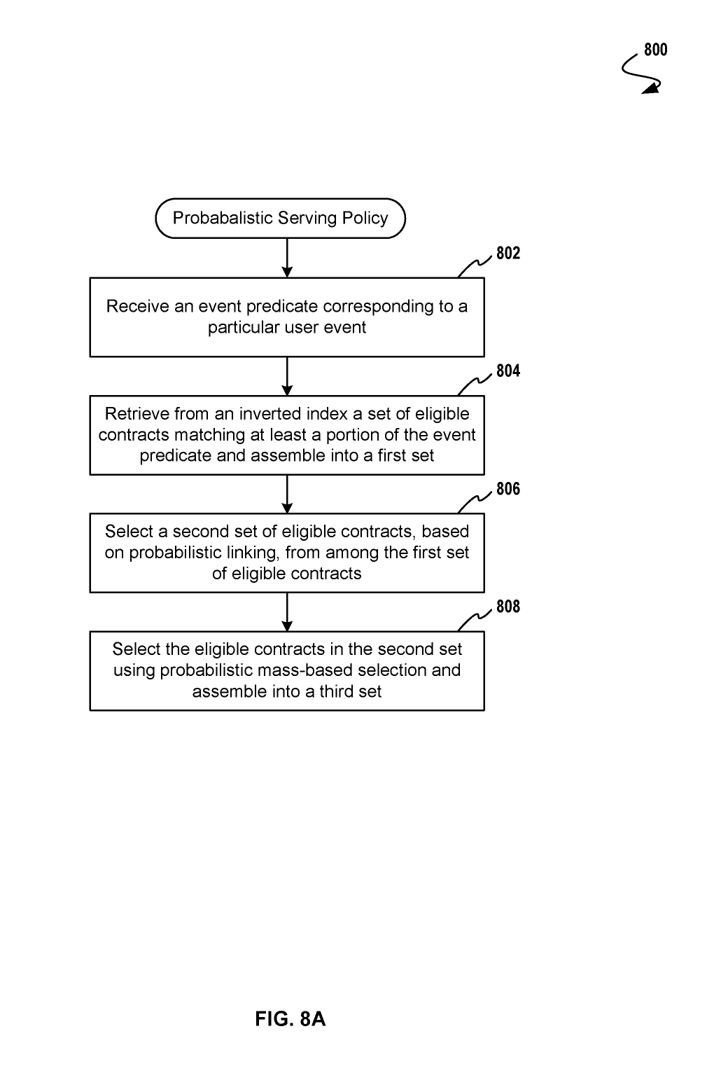

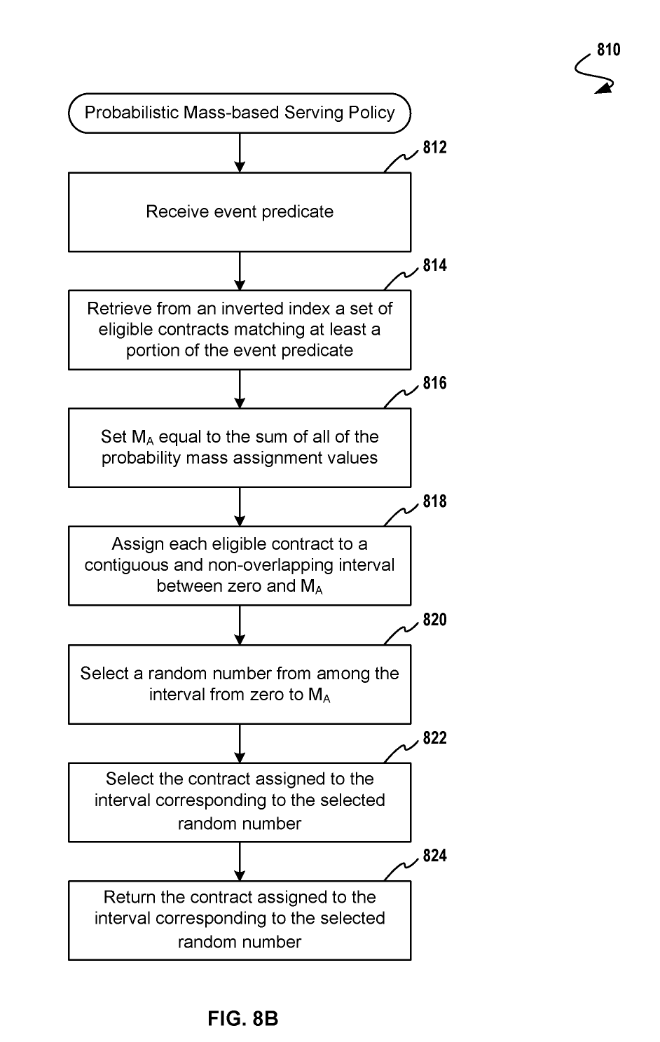

Now, returning to the earlier discussed topic of a serving policy, FIG. 8A depicts a flowchart of a method for implementing operations within a probabilistic policy for serving impressions in guaranteed delivery advertising. In particular, the method 800 serves to implement a probabilistic approach for serving impressions in guaranteed delivery advertising by selecting contracts for display to a particular user that observe an optimal or near-optimal allocation in expectation. That is, a probabilistic serving policy might be implemented in the context of contracts that are subjected to a mass-based probabilistic approach to serving, even when some of the contracts contain frequency caps. As shown, the method 800 might receive an event predicate corresponding to a particular user event (see operation 802) and, based at least in part on the event predicate, a first set of eligible contracts might be assembled. Of course, there are many techniques for retrieving eligible contracts from a set, possibly using an inverted index. In this embodiment, an eligible contract is a contract for which at least some portion of the contract's target predicates match the aforementioned event predicate (see operation 804). Next, among the first set of eligible contracts are selected a second set, those eligible contracts selected for the second set are selected on the basis of probabilistic linking as described in the discussions of FIG. 7B and FIG. 7C (see operation 806). The second set then contains contracts that are not only eligible to be served to the user corresponding to the received event predicate, but are also eligible to be served to this user in this visit (and without violating the frequency cap). Then, from among the contracts in the second set, one or more contracts are further selected using a probabilistic mass-based approach (see operation 808).

Now, in further describing the earlier discussed mass-based serving policy, FIG. 8B depicts a flowchart of a method for implementing operations within a mass-based approach for serving impressions in guaranteed delivery advertising. Of course, the method 810 for implementing operations within a mass-based approach for serving impressions in guaranteed delivery advertising is an exemplary embodiment, and some or all (or none) of the operations mentioned in the discussion of method 810 might be carried out in any environment. As shown, a serving policy might be implemented using some of all of the operations of method 810. In particular, an event predicate might be received by a server such as an additional content server 108 (see operation 812) and, based on the event predicate, a server might retrieve from an inverted index a set of eligible contracts. In some embodiments, an eligible contract is a contract for which at least some portion of the contract's target predicates match the aforementioned event predicate (see operation 814). Once the index has returned the set of eligible contracts, the values of the masses associated with each of the set of eligible contracts is summed (see operation 816). In the embodiment described, and having then the definition of a range (e.g. from zero to the aforementioned sum), each of the masses might be arranged in a contiguous and non-overlapping manner across the range (see operation 818). A parameterized random number generator might then be used to select a number from within the range (see operation 820). The generated random number may then be used to select one of the intervals, and the contract associated with that interval is then selected to be served (see operation 822). Once a contract has been selected, then system 810 may communicate with other modules within environment 100 for displaying (to the visitor precipitating the event predicate mentioned in operation 812), and an advertisement corresponding to the served contract might be communicated (see operation 824). As shown and described, this policy will serve the eligible contracts relatively evenly, and will meet the demands of the contracts within the limits, and with the likelihood, of the Chernoff bounds, as earlier described.

Of course, the foregoing mass-based approach as described does not indicate observation of frequency capping. Yet, as indicated in the description of FIG. 8A, operation 806 serves to observe frequency capping.

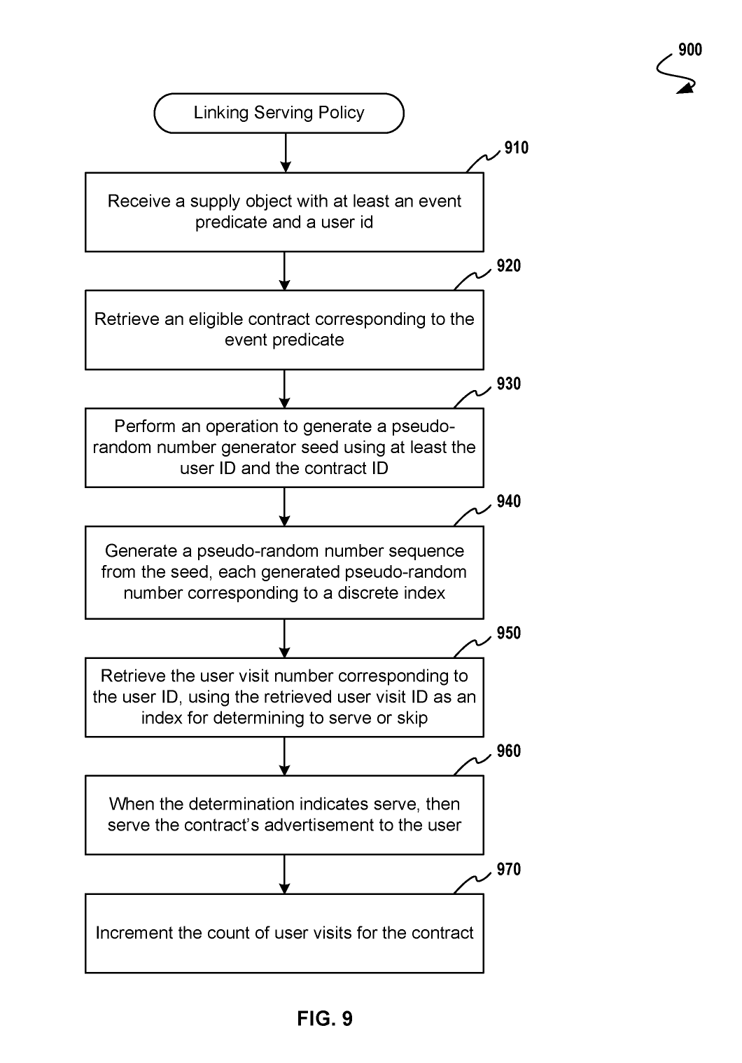

FIG. 9 depicts a flowchart of a method for implementing operations within a probabilistic linking approach for serving impressions in guaranteed delivery advertising. Of course, the method 900 is an exemplary embodiment, and some or all (or none) of the operations mentioned in the discussion of method 900 might be carried out in any environment. As shown, a probabilistic linking serving policy might be implemented using some of all of the operations of method 900, which method might commence by receiving a supply object with at least an event predicate and a user ID (see operation 910) and, using the event predicate, retrieve contracts, which retrieved contracts match the event predicate (see operation 920). For determining if one or more of the retrieved contracts should be served (or skipped) based on probabilistic linking, an indexed pseudo-random number sequence is generated (see operation 940) using a pseudo-random number generator seed, possibly using a hashing function from some combination of the user ID and any other fields in the supply object (see operation 930). In some cases a pseudo-random number generator seed is generated using a combination of the user ID and an identifier corresponding to the Internet property (e.g. Yahoo! Finance). Since the indexed pseudo-random number sequence can be thought of as an array, the user's visit number can be used to index into the indexed pseudo-random number sequence to retrieve one of the elements of the indexed pseudo-random number sequence (see operation 950). If the retrieved element is less than or equal to the frequency cap, then the advertisement corresponding to the contract can be served. Else the advertisement corresponding to the contract is not served in this visit (see operation 960). In either case, the count of user visits for this user (e.g. a value within or calculated from the count-value descriptor 670) is incremented (see operation 970). Of course, counts of user visits for a contract are reset at some point after the contract's frequency cap duration has expired.

Booking with Linking

The solution to the booking problem is similar to that described above, with the key difference being that it works with the linked eligibility graph. Linking is done using any one of the linking policies, both for the previously booked frequency-capped contracts, as well as for the new query (i.e. a query is not connected by edges to all its eligible user visits, but only to its linked user visits). Thus, with the linked eligibility graph (and using the relaxed integrality constraints), simply solve exactly the same formulation as for non-frequency capped contracts.

Planning with Linking

The compact allocation plan has an M for each time period, and a mass for each contract. As stated before, the predicted median visit number is used for M; the mass is calculated as before in a two-step process: first, the number of impressions that can be delivered to each contract with a buffer of ε given the most recent model of supply calculated and, next, given the demand which is feasible given the supply, a planning module (e.g. forecasting module 111, or an admission control and pricing module 115) can calculate a mass for each contract.

Serving with Linking

The compact allocation plan for the ad server is computed in exactly the same way as for non-frequency capped contracts, however, using a linked eligibility graph (note that the allocation problem reverts to having regular network flow constraints after linking, and can thus leverage the aforementioned compact allocation plans). Further, the linking policy, in particular the M value(s), are also sent to the ad server as part of a compact allocation plan.

Thus, given a user visit i by user U, the ad server first finds the set of eligible contracts E(i) as before. However, instead of considering all the eligible contracts, it only considers the linked contracts; i.e. only the contracts j such that iεL_{U}(j) (where L_{U}(j) is implicitly specified by the M value of the linking policy). Then, it works on the set of linked eligible contracts as before. For example, using the mass-based allocation method, it would probabilistically assign the user visit to contracts, with a probability that is proportional to the mass of the contract.

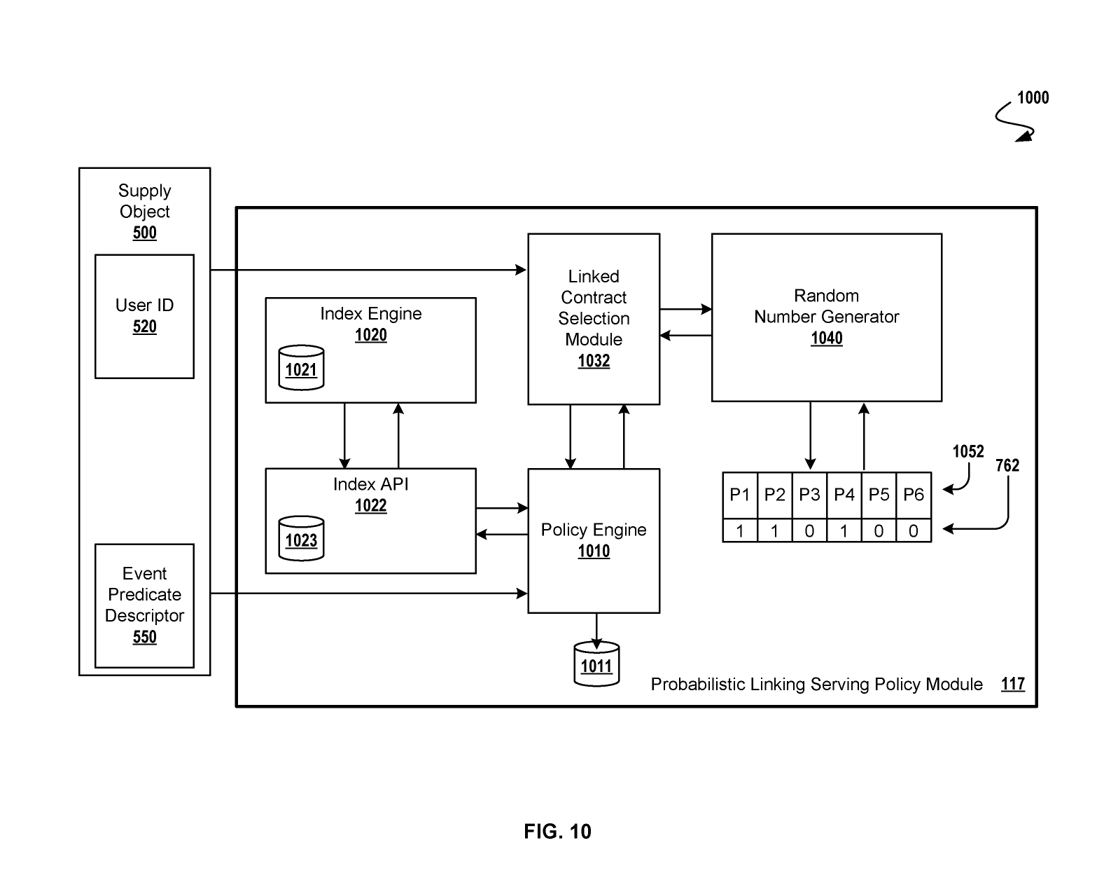

FIG. 10 depicts a system diagram of a system implementing operations within a probabilistic linking approach for serving impressions in guaranteed delivery advertising. Of course, the system 1000 is an exemplary embodiment, and some or all (or none) of the operations mentioned in the discussion of system 1000 might be carried out in any environment. As shown, a probabilistic linking serving policy module 117 includes a policy engine 1010 which in turn is in communication with an index engine 1020 through an index API 1022. In operation, the probabilistic linking serving policy module 117 is operable for serving impression opportunities to a booked contract by receiving, from a server, an event predicate descriptor 550 (possibly from a supply object 500) and retrieving, from an index 1021, possibly using an index engine 1020 and an index API 1022, a set of eligible contracts 1023, wherein an eligible contract comprises at least one target predicate matching at least a portion of the event predicate (e.g. from event predicate descriptor 550). A linked contract selection module 1032 serves for selecting at least one eligible contract from among the set of the eligible contracts 1023. A random number generator 1040 serves for generating a pseudo-random number sequence 1052, and possibly for generating a user-specific serve-skip indication 762. In exemplary embodiments, the random number generator 1040 might be parameterized so as to use one or more fields of the user visit description 510 (e.g. user ID 520, visit count, etc) for a hash value seed for generating a pseudo-random number sequence 1052. The system shown uses a policy engine 1010 for certain operations in order to probabilistically select booked contracts having a frequency cap specification, but only when the selected booked contract can be served to the user without violating the frequency cap specification.

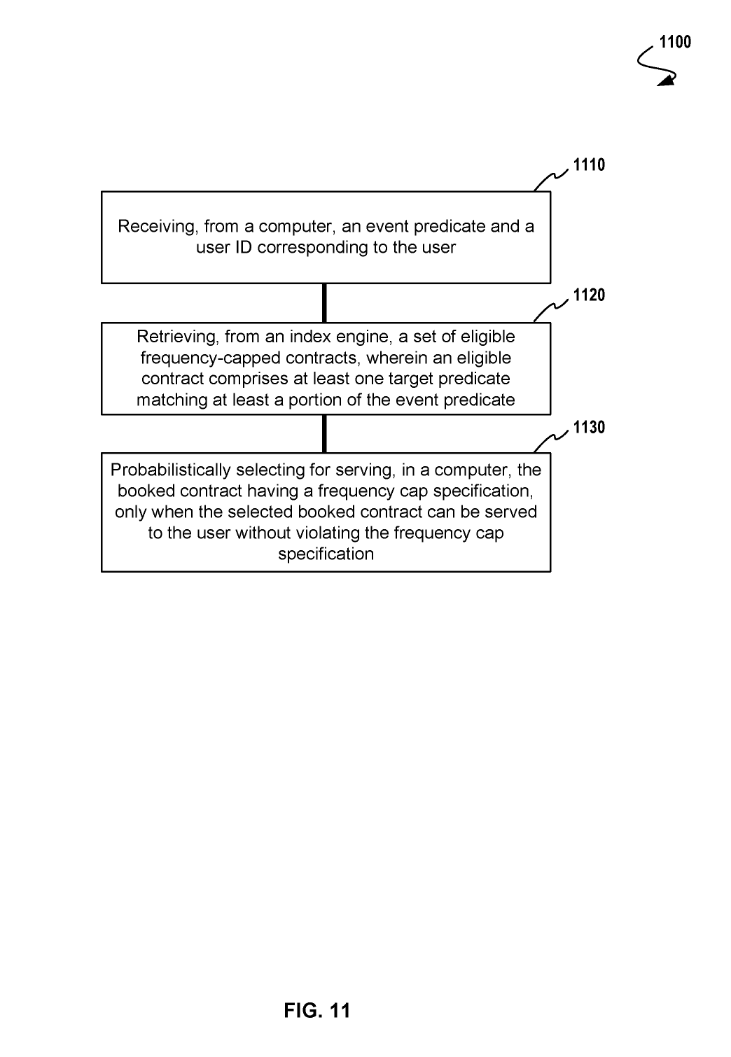

FIG. 11 depicts a flowchart of a method for delivery of display advertising to a user. As an option, the present method 1100 may be implemented in the context of the architecture and functionality of the embodiments described herein. Of course, however, the method 1100 or any operation therein may be carried out in any desired environment. As shown, method 1100 includes a plurality of operations, and the operations of the system can, individually or in combination, perform method steps within method 1100. Any method steps performed within method 1100 may be performed in any order unless as may be specified in the claims. As shown, method 1100 implements a method for delivery of display advertising to a user, the method 1100 comprising operations for: receiving, from a computer, an event predicate and a user ID corresponding to the user (see operation 1110); retrieving, from an index engine, a set of eligible frequency-capped contracts, wherein an eligible contract comprises at least one target predicate matching at least a portion of the event predicate (see operation 1120); and probabilistically selecting for serving, in a computer, the booked contract having a frequency cap specification, only when the selected booked contract can be served to the user without violating the frequency cap specification (see operation 1130).

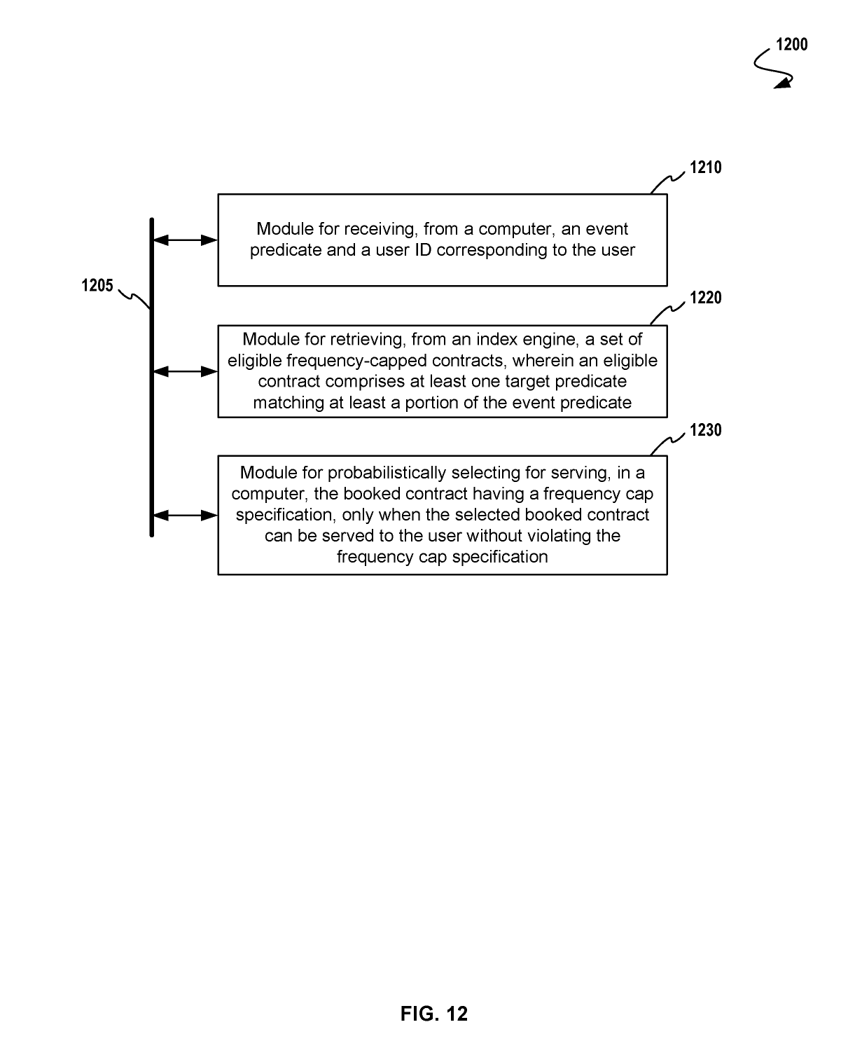

FIG. 12 depicts a block diagram of a system to perform certain functions of an advertising server network. As an option, the present system 1200 may be implemented in the context of the architecture and functionality of the embodiments described herein. Of course, however, the system 1200 or any operation therein may be carried out in any desired environment. As shown, system 1200 comprises a plurality of modules including a processor and a memory, each module connected to a communication link 1205, and any module can communicate with other modules over communication link 1205. The modules of the system can, individually or in combination, perform method steps within system 1200. Any method steps performed within system 1200 may be performed in any order unless as may be specified in the claims. As shown, FIG. 12 implements an advertising server network as a system 1200, comprising modules including a module for receiving, from a computer, an event predicate and a user ID corresponding to the user (see module 1210); a module for retrieving, from an index engine, a set of eligible frequency-capped contracts, wherein an eligible contract comprises at least one target predicate matching at least a portion of the event predicate (see module 1220); and a module for probabilistically selecting for serving, in a computer, the booked contract having a frequency cap specification, only when the selected booked contract can be served to the user without violating the frequency cap specification (see module 1230).

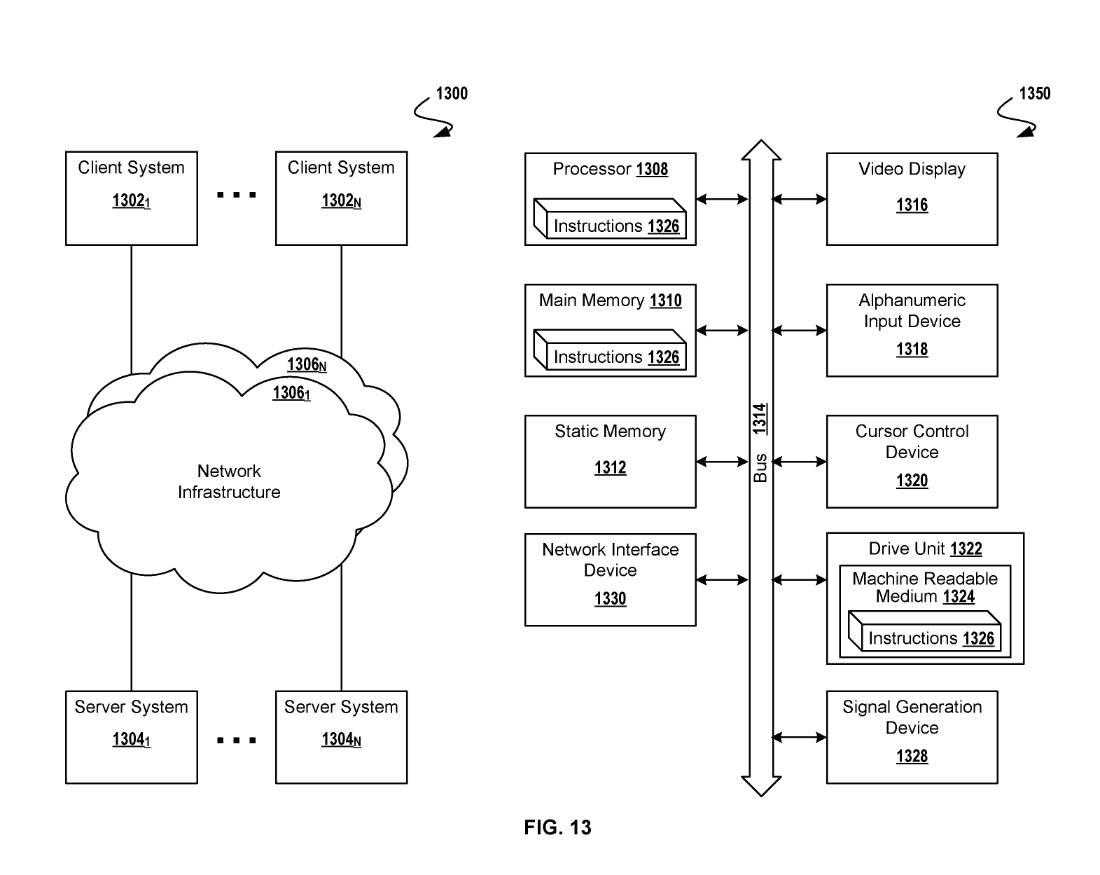

FIG. 13 is a diagrammatic representation of a network 1300, including nodes for client computer systems 1302₁ through 1302_{N}, nodes for server computer systems 1304₁ through 1304_{N}, nodes for network infrastructure 1306₁ through 1306_{N}, any of which nodes may comprise a machine 1350 within which a set of instructions for causing the machine to perform any one of the techniques discussed above may be executed. The embodiment shown is purely exemplary, and might be implemented in the context of one or more of the figures herein.

Any node of the network 1300 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1350 includes a processor 1308 (e.g. a processor core, a microprocessor, a computing device, etc), a main memory 1310 and a static memory 1312, which communicate with each other via a bus 1314. The machine 1350 may further include a display unit 1316 that may comprise a touch-screen, or a liquid crystal display (LCD), or a light emitting diode (LED) display, or a cathode ray tube (CRT). As shown, the computer system 1350 also includes a human input/output (I/O) device 1318 (e.g. a keyboard, an alphanumeric keypad, etc), a pointing device 1320 (e.g. a mouse, a touch screen, etc), a drive unit 1322 (e.g. a disk drive unit, a CD/DVD drive, a tangible computer readable removable media drive, an SSD storage device, etc), a signal generation device 1328 (e.g. a speaker, an audio output, etc), and a network interface device 1330 (e.g. an Ethernet interface, a wired network interface, a wireless network interface, a propagated signal interface, etc).

The drive unit 1322 includes a machine-readable medium 1324 on which is stored a set of instructions (i.e. software, firmware, middleware, etc) 1326 embodying any one, or all, of the methodologies described above. The set of instructions 1326 is also shown to reside, completely or at least partially, within the main memory 1310 and/or within the processor 1308. The set of instructions 1326 may further be transmitted or received via the network interface device 1330 over the network bus 1314.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for serving impression opportunities to a booked contract in a system for delivery of display advertising to a user, comprising:
receiving, from a computer, an event predicate and a user ID corresponding to the user;
retrieving, from an index engine, a set of eligible frequency-capped contracts, wherein an eligible contract comprises at least one target predicate matching at least a portion of the event predicate; and
probabilistically selecting for serving, in a computer, the booked contract having a frequency cap specification, only when the selected booked contract can be served to the user without violating the frequency cap specification.

2. The computer-implemented method of claim 1, wherein at least one of the set of frequency-capped contracts is displayed at most a specified number of times within a specified duration.

3. The computer-implemented method of claim 1, wherein the probabilistically selecting operation comprises selecting, in a computer, at least one selected event pseudo-random number from a series of pseudo-random numbers, the selected event pseudo-random number being based on the user ID and at least in part on at least one of, the Internet property URL, a visit count, a time period, a null.

4. The computer-implemented method of claim 1, wherein the frequency cap specification contains a frequency count-value descriptor, said frequency count-value descriptor including a frequency count integer value.

5. The computer-implemented method of claim 1, further comprising at least one of, storing a user visit count-value descriptor, incrementing a user visit count-value descriptor.

6. The computer-implemented method of claim 2 wherein the series of pseudo-random numbers contains M elements in the series, and wherein M is larger than the frequency count integer value.

7. The computer-implemented method of claim 1, wherein the probabilistically selecting operation includes at least two booked contracts.

8. The computer-implemented method of claim 5, further comprising storing an M-value descriptor.

9. The computer-implemented method of claim 1, further comprising selecting based on, at least in part, the masses of the eligible frequency-capped contracts.

10. An advertising server network for serving impression opportunities to a booked contract in a system for delivery of display advertising to a user, comprising:
a module for receiving, from a computer, an event predicate and a user ID corresponding to the user;
a module for retrieving, from an index engine, a set of eligible frequency-capped contracts, wherein an eligible contract comprises at least one target predicate matching at least a portion of the event predicate; and
a module for probabilistically selecting for serving, in a computer, the booked contract having a frequency cap specification, only when the selected booked contract can be served to the user without violating the frequency cap specification.

11. The advertising server network of claim 10, wherein at least one of the set of frequency-capped contracts is displayed at most a specified number of times within a specified duration.

12. The advertising server network of claim 10, wherein the probabilistically selecting operation comprises selecting, in a computer, at least one selected event pseudo-random number from a series of pseudo-random numbers, the selected event pseudo-random number being based on the user ID and at least in part on at least one of, the Internet property URL, a visit count, a time period, a null.

13. The advertising server network of claim 10, wherein the frequency cap specification contains a frequency count-value descriptor, said frequency count-value descriptor including a frequency count integer value.

14. The advertising server network of claim 11 further comprising at least one of, storing a user visit count-value descriptor, incrementing a user visit count-value descriptor.

15. The advertising server network of claim 12 wherein the series of pseudo-random numbers contains M elements in the series, and wherein M is larger than the frequency count integer value.

16. The advertising server network of claim 10, wherein probabilistically selecting includes at least two booked contracts.

17. The advertising server network of claim 14, further comprising storing an M-value descriptor.

18. The advertising server network of claim 10, further comprising selecting based on, at least in part, the masses of the eligible frequency-capped contracts.

19. A computer readable medium comprising a set of instructions which, when executed by a computer, cause the computer to serve impression opportunities to a booked contract in a system for delivery of display advertising to a user, the set of instructions for:
receiving, from a computer, an event predicate and a user ID corresponding to the user;
retrieving, from an index engine, a set of eligible frequency-capped contracts, wherein an eligible contract comprises at least one target predicate matching at least a portion of the event predicate; and
probabilistically selecting for serving, in a computer, the booked contract having a frequency cap specification, only when the selected booked contract can be served to the user without violating the frequency cap specification.

20. The computer readable medium of claim 19, wherein at least one of the set of frequency-capped contracts is displayed at most a specified number of times within a specified duration.

21. The computer readable medium of claim 19, wherein the probabilistically selecting operation comprises selecting, in a computer, at least one selected event pseudo-random number from a series of pseudo-random numbers, the selected event pseudo-random number being based on the user ID and at least in part on at least one of, the Internet property URL, a visit count, a time period, a null.

22. The computer readable medium of claim 19, wherein the frequency cap specification contains a frequency count-value descriptor, said frequency count-value descriptor including a frequency count integer value.

23. The computer readable medium of claim 19, further comprising at least one of, storing a user visit count-value descriptor, incrementing a user visit count-value descriptor.
